(19) United States
(12) Patent Application Publication
(10) Pub. No.: US 2009/0104429 A1
(43) Pub. Date: Apr. 23, 2009

(54) RESIN COMPOSITION, SHEET-LIKE FORMED BODY, PREPREG, CURED BODY, LAMINATE, AND MULTILAYER LAMINATE

(75) Inventors: Nobuhiro Goto, Ibaraki (JP); Hiroshi Kouyanagi, Ibaraki (JP); Takayuki Kobayashi, Ibaraki (JP); Masaru Heishi, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SEKISUI CHEMICAL CO., LTD., OSAKA (JP)

(21) Appl. No.: 12/066,893

(22) PCT Filed: Sep. 14, 2006
(86) PCT No.: PCT/JP2006/318240

§ 371 Date: Mar. 14, 2008

(30) Foreign Application Priority Data
Sep. 15, 2005 (JP) 2005-268462

(51) Int. Cl. B32B 3/26; C08L 63/00; B32B 15/092

(52) U.S. Cl. 428/319.3; 524/611; 428/457

(57) ABSTRACT

Provided is a resin composition, a prepreg, a cured body, a sheet-like formed body, a laminate, and a multilayered laminate using the resin composition, the resin composition including an epoxy resin and an inorganic filler. For example, when a second layer is formed onto the surface of a cured body, the cured body has improved adhesive property or adhesive property between the cured body and the second layer. A resin composition comprising an epoxy resin, a curing agent for the epoxy resin, a silica treated with an imidazole silane and having a mean particle diameter not more than 5 micrometers, the resin composition including the silica at a proportion of 0.1 to 80 parts by weight to a mixture consisting of the epoxy resin and the curing agent for the epoxy resin 100 parts by weight.

### TECHNICAL FIELD

The present invention relates to a resin composition including a resin and an inorganic filler, and specifically relates to, for example, a resin composition usable for substrates having a copper plated layer, etc. formed thereon, and to a prepreg, a cured body, a sheet-like formed body, a laminate, and a multilayered laminate using the resin composition.

Conventionally, for example, resin compositions including epoxy resins including fillers treated with imidazole silanes have been used as resins for semiconductor devices, and various experiments have been performed for improving the adhesive performance of the resin compositions.

Following Patent Document 1 describes a resin composition including a filler treated with a specific imidazole silane or a mixture of specific imidazole silanes as a sealing resin for semiconductor devices. Imidazole groups existing on the surface of the filler, in this resin composition, work as a curing catalyst and a starting point of a reaction. And thereby, curing of the resin composition can increase the strength of the resulting cured body of the resin owing to easily formed chemical bonds. Accordingly, extraordinary usefulness in case of necessity of adhesive property is admitted for the resin composition of Patent Document 1.

On the other hand, Patent Document 2 describes an epoxy resin composition including an imidazole silane having alkoxy silyl groups, or a dimethylamino silane having alkoxy silyl groups. This epoxy resin composition has excellent curing property, adhesive property, and storage stability. Furthermore, Patent Document 2 also describes that use of a phenol resin as a curing agent gives an insufficient adhesive property of copper foils with respect to epoxy resins for laminates.

Patent Document 3 describes an epoxy resin composition including an imidazole silane (D) without a direct bond between Si atom and N atom at a proportion of 0.01 to 2.0 parts by weight in a resin composition including an epoxy resin (A), a phenol resin (B), and an inorganic filler (C). This epoxy resin composition is found to have excellent adhesive property to semiconductor chips, and to give no separation after IR reflow, and further to have excellent moisture resistance.

### [Patent Document 1]

### JP, 9-169871, A

### [Patent Document 2]

### JP, 2001-187836, A

### [Patent Document 3]

### JP, 2002-128872, A

### DESCRIPTION OF THE INVENTION

Since the resin compositions described in Patent Documents 1 to 3 include fillers treated with imidazole silanes, it is expected that fairly excellent adhesive property with, for example, metals such as copper foils may be provided.

Roughening treatment is generally performed for resin compositions used for substrates for circuits, etc. in order to further enhance adhesive property. The roughening treatment gives an uneven shape to a surface of a resin by dissolution or degradation of the resin itself with a solution for roughening treatment, and thereby the treatment enhances the adhesive property of the surface of the resin and, furthermore provides an anchoring effect.

In recent years, much smaller L/S than conventionally used L/S of copper wirings is being needed. Accordingly, a circuit board needing thinness of insulating layers require smaller surface roughness after roughening treatment. However, a smaller surface roughness sometimes lowers the adhesive property of the resin composition for forming insulating layers in formation of metal layers such as copper plating, onto the surface of the cured body. In order to enhance adhesive property, use of larger surface roughness by roughening treatment was forced, leading to difficulty of measure for miniaturization of wirings. Furthermore, there may occur problems that even in case of an attempt for removal silica in the roughening treatment, the difficulty of etching of the resin itself does not allow remove of the silica. Therefore, it is necessary to use resins that accept easy etching. However, resins that may easily be etched show a tendency to give larger surface roughness, and in addition the resins have a problem to give larger variation in surface roughness. Conversely, use of resins that is hard to be etched in roughening treatment has a problem of difficulty of remove of the silica.

In view of the above-described conventional technologies, an object of the present invention is to provide a resin composition including an epoxy resin, a curing agent for the epoxy resin, and a silica treated with an imidazole silane, the resin composition having improved adhesive property or adhesive property between a cured body and a second layer, for example, in case of formation of the second layer to the surface of the cured body, a prepreg, a cured body, a sheet-like formed body, a laminate using the resin composition, and a multilayered laminate.

The present invention provides a resin composition comprising: an epoxy resin; a curing agent for the epoxy resin; and a silica treated with an imidazole silane, the silica having a mean particle diameter not more than 5 micrometers, the resin composition including the silica at a proportion of 0.1 to 80 parts by weight to a mixture consisting of the epoxy resin and the curing agent for the epoxy resin 100 parts by weight.

In a specific aspect of the resin composition according to the present invention, the silica has a mean particle diameter not more than 1 micrometer.

In an other specific aspect of the resin composition according to the present invention, the silica has a maximum particle diameter not more than 5 micrometers.

In an other specific aspect of the resin composition according to the present invention, the resin composition further includes an organized layered-silicate at a proportion of 0.01 to 50 parts by weight to a mixture consisting of the epoxy resin and the curing agent for the epoxy resin 100 parts by weight. In an other specific aspect of the resin composition according to the present invention, the curing agent is an active ester compound, and has a dielectric constant not more than 3.1 and a dielectric loss tangent not more than 0.009 at 1 GHz after heated-curing.

The prepreg concerning the present invention is obtained by impregnation of a resin composition formed according to the present invention to a porous base material.

The cured body concerning the present invention is obtained by roughening treatment to a cured body of the resin obtained by heated-curing of the resin composition formed according to the present invention, or of the prepreg formed according to the present invention, and the cured body has a surface roughness Ra not more than 0.2 micrometers, and a surface roughness Rz not more than 2.0 micrometers.

In a specific aspect of the cured body concerning the present invention, a swelling treatment is given to the cured body before the roughening treatment of the cured body of the resin.

The sheet-like formed body concerning the present invention uses a resin composition formed according to the present invention, a prepreg formed according to the present invention, or a cured body formed according to the present invention.

In the laminate concerning the present invention, a metal layer and/or an adhesive layer having adhesive property are formed at least on one side of the sheet-like formed body formed according to the present invention.

In a specific aspect of the laminate concerning the present invention, the metal layer is formed as a circuit.

In a multilayered laminate concerning the present invention, there is formed at least one kind of laminate selected from laminates that have been formed according to the present invention. The multilayered laminate of the present invention is a multilayered laminate obtained by roughening treatment to a resin laminated cured body obtained by preferably laminating one of the resin compositions concerning the present invention, or the sheet-like formed body concerning the present invention or the prepreg to the laminate concerning the present invention, and by heated-curing the resin laminated cured body, and the multilayered laminate has a surface roughness Ra not more than 0.2 micrometers and a surface roughness Rz not more than 2.0 micrometers.

### EFFECT OF THE INVENTION

A resin composition of the present invention comprises: an epoxy resin; a curing agent for the epoxy resin; a silica treated with an imidazole silane, the silica having a mean particle diameter not more than 5 micrometers. Since the resin composition in the present invention comprises the above-described silica at a proportion of 0.1 to 80 parts by weight to a mixture 100 parts by weight consisting of the curing agent for the epoxy resin and the epoxy resin, the roughening treatment of the resin composition after heat-treatment allows easy removal of the silica without much etching, thereby resulting in the smaller surface roughness of the cured body. Accordingly, the cured body having smooth resin part and excellent adhesive property to copper platings with fine unevenness formed thereon after removal of the silica with a mean particle diameter not more than 5 micrometers may be obtained.

In the present invention, the roughening treatment after heated-curing of the resin composition forms a plurality of fine pores in the surface of the cured body by removal of the silica. Accordingly, in the case of formation of metal plating layers such as made of copper, etc., in the surface of the cured body, the metal plating layer also reaches inside the plurality of pores formed in the surface, thereby allowing improved adhesive property between the cured body and the metal plating owing to a physical anchoring effect.

In the case where the mean particle diameter of the silica is not more than 1 micrometer, for example, further swelling and roughening treatment after heated-curing of the resin composition enables much easier removal of the silica treated with imidazole silanes. Furthermore, a smaller mean particle diameter of the silica results in easier remove of the silica, and in formation of finer pores. Thereby, a finer uneven surface may be formed in the surface of the cured body. Accordingly, in the case of formation of metal plating layers such as made of copper, etc., in the surface of the cured body, further improved adhesive property between the cured body and the metal plating may be obtained.

When the maximum particle diameter of the silica is not more than 5 micrometers, for example, the further swelling and roughening treatment after heated-curing of the resin composition may form uniform and fine unevenness in the surface of the cured body, avoiding formation of a comparatively coarser unevenness. Accordingly, in the case of formation of metal plating layers such as made of copper, etc., in the surface of the cured body, further improved adhesive property between the cured body and the metal plating may be obtained. On the other hand, the maximum particle diameter of the silica exceeding 5 micrometers does not allow easy removal of the silica even after roughening treatment, and a certain portion may not form pores, failing to allow the easy formation of uniform pores.

When an organized layered-silicate is further included at a proportion of 0.01 to 50 parts by weight to a mixture consisting of the epoxy resin, and the curing agent for the epoxy resin 100 parts by weight, the organized layered-silicate will be distributed in a circumference of the silica treated with an imidazole silane. Therefore, for example, swelling and roughening treatment after curing of this resin composition can remove much more easily the silica treated with imidazole silanes that exists on the surface of the cured body, accordingly leading to formation of the finer and more uniform uneven surface in the surface of the cured body. For this reason, adhesive property between the cured body and the metal plating may be improved in the case of formation of a metal plating layer, etc. such as made of copper onto the surface of the cured body.

In the prepreg according to the present invention, the resin composition is impregnated within a porous base material. Accordingly, roughening treatment after curing of the resin composition impregnated in the porous base material can make a surface roughness of the cured body smaller. Thereby, in the case of formation of metal plating layers such as made of copper, etc., in the surface of the cured body, further improved adhesive property between the cured body and the metal plating may be obtained. Therefore, component parts provided with high-reliability having excellent adhesive property to metal plating layers may be obtained for the use of components for circuit formation by metal platings, for example, components for formation of electronic circuits such as build up substrates, and components for formation of terminal member as in antennas made of resins. Publicly known techniques, for example, etching method etc. may be used for formation of the circuits.

The cured body of the present invention is obtained by performing roughening treatment to the cured body of the resin obtained by heated-curing of the resin composition formed according to the present invention, or the prepreg formed according to the present invention. The cured body has a plurality of pores having a mean diameter not more than 5 micrometers on the surface thereof. Since the cured body has a surface roughness Ra not more than 0.2 micrometers, and a surface roughness Rz not more than 2.0 micrometers, the surface roughness of the cured body will be small. Accordingly, in the case of formation of metal plating layers such as made of copper, etc., in the surface of the cured body, further improved adhesive property between the cured body and the metal plating layer may be obtained. Furthermore, a smaller surface roughness of the cured body can improve high speed signal processing performance in the case of formation of copper wirings having smaller L/S value onto the cured body. Since the surface roughness of the surface of the cured body is smaller, an advantage of the smaller loss of electrical information in an interface of the copper plating and the cured body will be exhibited in the case of use with a high frequency signal having a frequency not less than 5 GHz. Furthermore, since the cured body has small anchor pores with a size of not more than 5 micrometers, pattern formation having smaller L/S may be possible. For example, also in case of pattern formation having not more than 10/10 of the L/S, smaller anchored pores may eliminate the possibility of the short circuit of wirings, and allow the formation of a high-density wiring. In spite of smaller surface roughness, the present invention can improve the adhesive property of the copper plating layer, leading to a greatly different point compared with conventional technologies. Furthermore, use of active ester compounds as a curing agent may provide cured bodies having excellent dielectric constant and dielectric loss tangent. That is, the present invention can provide a cured body having a dielectric constant not more than 3.1 and a dielectric loss tangent not more than 0.009 at 1 GHz. The present invention can provide excellent adhesive property with metal platings, and excellent dielectric constant and dielectric loss tangent in spite of smaller surface roughness, leading to a large difference with respect to conventional technologies.

Furthermore, use of the cured body of the present invention allows the formation of fine wirings in application such as copper foils with resins, copper clad laminated substrates, printed circuit boards, prepregs, adhesive sheets and tapes for TAB, leading to improved high speed signal transmission.

Swelling processing given to the cured body according to the present invention before the roughening treatment of the cured body of the resin enables the silica treated with an imidazole silane to be removed much easier. Accordingly, the formation of fine pores resulting from removal of the silica allows the formation of finer unevenness in the surface of the cured body.

Since the sheet-like formed body of the present invention uses the resin composition, the prepreg, or the cured body formed according to the present invention, the sheet-like formed body has an excellent mechanical strength such as a tensile strength, and an excellent coefficient of linear expansion, and also has a heightened glass transition temperature Tg.

In the laminate according to the present invention, a metal layer and/or an adhesive layer having adhesive property are formed at least on one side of the sheet-like formed body. In this laminate, the adhesive property among the uneven surface of the surface of the sheet-like formed body, the metal layer and/or the adhesive layer, and the sheet-like formed body is improved to give excellent reliability of adhesive property.

When the metal layer is formed as a circuit, the metal layer is firmly contacted with respect to the surface of the sheet-like formed body, and therefore the reliability of the circuit including the metal layer will be improved.

In the multilayered laminate according to the present invention, at least one kind of the laminate selected from the laminates formed according to the present invention is used. Accordingly, in the multilayered laminate according to the present invention, the adhesive property between the sheet-like formed body, and the metal layer and/or the adhesive layer is improved. Furthermore, when the resin composition is interposed in an interface between a plurality of the laminates, the reliability of junction between the laminates is improved.

### BEST MODE FOR CARRYING OUT OF THE INVENTION

Hereinafter, details of the present invention will be described.

The resin composition of the present invention includes an epoxy resin, a curing agent for the epoxy resin, and a silica being treated with an imidazole silane and having a mean particle diameter not more than 5 micrometers.

### (Epoxy Resin)

Epoxy resins represent organic compounds having at least one epoxy group (oxirane ring).

The number of the epoxy groups in the above-described epoxy resin is preferably one or more per molecule, and more preferably two or more per molecule. Conventionally publicly known epoxy resins may be used as the epoxy resins, and, for example, epoxy resin (1) to epoxy resin (11), etc. illustrated hereinafter may be mentioned. These epoxy resins may be used independently and two or more kinds may be used in combination. Derivatives or hydrogenated compounds of such epoxy resins may be used as the epoxy resins.

Bisphenol type epoxy resins and novolak type epoxy resins may be mentioned as the above-described epoxy resin (1) that is aromatic epoxy resins. The bisphenol type epoxy resins include, for example, bisphenol A type epoxy resins, bisphenol F type epoxy resins, bisphenol AD type epoxy resins, bisphenol S type epoxy resins, etc. The novolak type epoxy resins include phenol novolak type epoxy resins, cresol novolak type epoxy resins, etc. Furthermore, the above-described epoxy resin (1) includes epoxy resins, phenol aralkyl type epoxy resins, etc. having aromatic rings such as naphthalene and biphenyl, in the principal chain thereof. In addition, epoxy resins, etc. including aromatic compounds such as trisphenol methane triglycidyl ether, may be mentioned.

The above-described epoxy resin (2) that is alicyclic epoxy resin includes, for example, 3,4-epoxycyclohexyl methyl-3,4-epoxy cyclohexane carboxylate, 3,4-epoxy-2-methylcyclohexylmethyl-3,4-epoxy-2-methylcyclohexane carboxylate, bis(3,4-epoxycyclohexyl)adipate, bis(3,4-epoxycyclohexyl methyl)adipate, bis (3,4-epoxy-6-methylcyclohexylmethyl)adipate, 2-(3,4-epoxycyclohexyl-5,5-spiro-3,4-epoxy)cyclohexanone metha-dioxane, bis(2,3-epoxy cyclopentyl)ether etc. As examples marketed among the epoxy resins (2), for example, products manufactured by Daicel Chemical Industries, Ltd. under the trade name of “EHPE-3150” (softening temperature of 71 degrees C.), etc. may be mentioned.

The above-described epoxy resin (3) that is aliphatic epoxy resin includes, for example, diglycidyl ether of neopentyl glycol, diglycidyl ether of 1,4-butanediol, diglycidyl ether of 1,6-hexandiol, triglycidyl ether of glycerin, triglycidyl ether of trimethylolpropane, diglycidyl ether of polyethylene glycol, diglycidyl ether of polypropylene glycol, poly glycidyl ethers of long chain polyols including polyoxy alkylene glycol having alkylene group with carbon numbers of 2 to 9 (preferably 2 to 4), polytetramethylene ether glycol, etc.

The above-described epoxy resin (4) that is glycidyl ester type epoxy resin includes, for example, diglycidyl ester phthalate, diglycidyl tetrahydrophtalate, diglycidyl hexahydrophthalate, diglycidyl p-oxybenzoate, glycidyl ether-glycidyl ester of salicylic acid, dimer acid glycidyl ester etc.

The above-described epoxy resin (5) that is glycidyl amine type epoxy resin includes, for example, triglycidyl isocyanurate, N,N′-diglycidyl derivatives of cyclic alkylene urea, N,N,O-triglycidyl derivatives of p-aminophenol, N,N,O-triglycidyl derivatives of m-aminophenol etc.

The above-described epoxy resin (6) that is glycidyl acrylic type epoxy resin includes, for example, copolymers of glycidyl (meth)acrylate, and radical polymerizable monomers, such as ethylene, vinyl acetate, and (meth) acrylic acid ester, etc.

The above-described epoxy resin (7) that is polyester type epoxy resin includes A, for example, polyester resins having one or more, preferably two or more epoxy groups per molecule etc.

The above-described epoxy resin (8) includes A, for example, epoxidized polybutadienes, polymers having conjugated diene compounds such as epoxidized dicyclopentadiene, as a principal component, or compounds obtained by epoxidation of double bonds of unsaturated carbons in polymers of partially hydrogenated compounds of the polymers etc.

The above-described epoxy resin (9) includes compounds obtained by epoxidation of double bonds of unsaturated carbons of conjugated diene compounds in block copolymers having a polymer block with a vinyl aromatic compound as a principal component, a polymer block having conjugated diene compound as a principal component, or a polymer block of a partially hydrogenated compound of the polymer in the same molecule etc. Such compounds include, for example, epoxidized SBS, etc.

The above-described epoxy resin (10) includes, for example, urethane modified epoxy resins, polycaprolactone modified epoxy resins, etc. obtained by introduction of urethane bonds or polycaprolactone bonds into the structure of the above-described epoxy resin (1) to (9). The above-described epoxy resin (11) includes epoxy resins having a bis aryl fluorene skeleton. Examples marketed among such epoxy resins (11) include “On-coat EX series” manufactured by Osaka Gas Chemicals, etc.

In the case of design for low elastic components in structures of resins, flexible epoxy resins are preferably used as epoxy resins. As the flexible epoxy resins, resins having flexibility after curing are preferred.

The flexible epoxy resins include diglycidyl ethers of polyethylene glycol, diglycidyl ethers of polypropylene glycol, polyglycidyl ethers of long chain polyols including polyoxy alkylene glycols, polytetramethylene ether glycols, etc. having alkylene group of carbon numbers of 2 to 9 (preferably 2 to 4), copolymers of glycidyl (meth)acrylate and radical polymerizable monomers such as ethylene, vinyl acetate, or (meth) acrylic acid esters, polymers obtained by epoxidation of double bonds of unsaturated carbons in (co)polymers having conjugated diene compounds as a principal component or (co)polymers obtained by partial hydrogenation of the (co)polymers, polyester resins having one or more, preferably two or more epoxy groups per molecule, urethane modified epoxy resins and polycaprolactone modified epoxy resins obtained by introduction of urethane bonds or polycaprolactone bonds, dimer acid modified epoxy resins obtained by introduction of epoxy groups into dimer acids or derivatives thereof, rubber modified epoxy resins obtained by introduction of epoxy groups into rubber compositions such as NBR, CTBN, polybutadienes, and acrylic rubbers etc.

Compounds having epoxy group and butadiene skeleton in the molecule thereof are more preferably used as the above-described flexible epoxy resin. Use of the flexible epoxy resin having butadiene skeleton can further improve the flexibility of the resin composition and the cured body therefrom, and also can improve elongation of the cured body over a wider temperature range from low temperature regions to high temperature regions.

The resin composition may include, if necessary, for example, in addition to the epoxy resin, resins copolymerizable with the epoxy resin the curing agent for the epoxy resin, and the silica treated with an imidazole silane that are essential components.

The above-described copolymerizable resins are not in particular limited, and for example, phenoxy resins, thermal curing type modified polyphenylene ether resins, benzoxazine resins, etc. may be mentioned. These copolymerizable resins may be used independently and two or more kinds may be used in combination.

The above-described thermal-curing type modified polyphenylene ether resins are not in particular limited, and for example, resins obtained by modification of polyphenylene ether resins with functional groups having thermal curing property such as epoxy groups, isocyanate groups, and amino groups, etc. may be mentioned. These thermal-curing type modified polyphenylene ether resins may be used independently and two or more kinds may be used in combination. As examples of resins modified by epoxy groups among the thermal-curing type modified polyphenylene ether resins, “OPE-2Gly” manufactured by Mitsubishi Gas Chemical Co., Inc., etc. may be mentioned.

The above-described benzoxazine resins include benzoxazine monomer or oligomers, and resins obtained by ring opening polymerization of oxazine rings thereof. The above-described benzoxazines are not in particular limited, and, for example, benzoxazines having substituent having aryl group skeletons such as methyl group, ethyl group, phenyl group, biphenyl group, cyclohexyl group, etc. bonded to nitrogen of the oxazine ring, and benzoxazines having substituents that are bonded between nitrogen atoms of two oxazine rings, having allylene group skeletons such as methylene group, ethylene, phenylene group, biphenylene group, naphthalene group, and cyclohexylene group may be mentioned. These benzoxazine monomers or oligomers, and benzoxazine resins may be used independently and two or more kinds may be used in combination.

### (Curing Agent for the Epoxy Resin)

The resin compositions of the present invention include epoxy resin curing agents for the epoxy resin.

The blending ratio of the curing agent in the resin composition is preferably 1 to 200 parts by weight with respect to the epoxy resin 100 parts by weight. The curing agents less than 1 part by weight may not sometimes allow sufficient curing of the epoxy resin, and the curing agent exceeding 200 parts by weight may sometimes be excessive for curing of the epoxy resin.

The above-described curing agents are not in particular limited, but conventionally publicly known curing agents for epoxy resins may be used, and for example, dicyandiamide, amine compounds, compounds synthesized from amine compounds, tertiary amine compounds, imidazole compounds, hydrazide compounds, melamine compounds, phenolic compounds, active ester compounds, benzoxazine compounds, heat-latent cationic polymerization catalysts, optical-latent cationic initiators, derivatives of the above-mentioned compounds, etc. may be mentioned. These curing agents may be used independently and two or more kinds may be used in combination. Furthermore, derivatives of these curing agents may be used with the curing agents as resin curing catalysts such as acetylacetone iron.

The above-described amine compounds include, for example, linear fatty amine compounds, cyclic fatty amines, aromatic amines, etc.

The above-described linear fatty amine compounds include, for example, ethylenediamine, diethylenetriamine, triethylenetetramine, tetraethylenepentamine, polyoxy propylenediamine, polyoxypropylene tiiamine, etc.

The above-described cyclic fatty amine compounds include, for example, menthenediamine, isophorone diamine, bis(4-amino-3-methylcyclohexyl) methane, diaminohexylmethane, bis(aminomethyl)cyclohexane, N-aminoethyl piperazine, 3,9-bis(3-aminopropyl)-2,4,8,10-tetraoxaspiro(5,5) undecane, etc.

The above-described aromatic amine compounds include m-xylenediamine, α-(m/p-aminophenyl)ethylamine, m-phenylenediamine, diaminodiphenylmethane, diaminodiphenyl sulfone, α,α-bis(4-aminophenyl)-p-diisopropylbenzene, etc.

The above-described compounds synthesized from the amine compounds include, for example, polyaminoamido compounds, polyaminoimido compounds, ketimine compounds, etc.

The above-described polyaminoamido compounds include, for example, compounds synthesized from the above-described amine compounds and carboxylic acids, etc. The carboxylic acids include, for example, succinic acid, adipic acid, azelaic acid, sebacic acid, dodecanoic diacid, isophthalic acid, terephthalic acid, dihydroisophthalic acid, tetrahydro isophthalic acid, hexahydro isophthalic acid, etc.

The above-described polyaminoimido compounds include, for example, compounds are synthesized from the above-described amine compounds and maleimide compounds, etc. The maleimide compounds, for example, include diaminodiphenylmethane bismaleimide, etc.

The above-described ketimine compounds include, for example, compounds synthesized from the above-described amine compounds and ketone compounds, etc.

In addition, the compounds synthesized from the above-described amine compound include, for example, compounds synthesized from the above-described amine compounds, and compounds such as epoxy compounds, urea compounds, thiourea compounds, aldehyde compounds, phenolic compounds, and acrylic compounds.

The above-described tertiary amine compounds include, for example, N,N-dimethylpiperazine, pyridine, picoline, benzyldimethylamine, 2-(dimethyl aminomethyl)phenol, 2,4,6-tris(dimethyl aminomethyl)phenol, and 1,8-diazabiscyclo(5,4,0)undecene-1.

The above-described imidazole compounds include, for example, 2-ethyl-4-methylimidazole, 2-methylimidazole, 2-undecylimidazole, 2-heptadecyl imidazole, 2-phenylimidazole, 1-benzyl-2-methylimidazole, 1-benzyl-2-phenylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecylimidazolium trimellitate, 2,4-diamino-6-[2′-methyl imidazolyl (1′)]-ethyl-s-triazine, 2,4-diamino-6-[2′-undecyl imidazolyl (1′)]-ethyl-s-triazine, 2,4-diamino-6-[2′-ethyl-4′-methyl imidazolyl (1′)]-ethyl-s-triazine, adducts of 2,4-diamino-6-[2′-methyl imidazolyl (1′)]-ethyl-s-triazine isocyanuric acid, adducts of 2-phenylimidazolisocyanuric acid, adducts of 2-methylimidazolisocyanuric acid, 2-phenyl-4,5-dihydroxymethylimidazole, 2-phenyl-4-methyl-5-hydroxymethylimidazole, 2-phenylimidazoline, 2,3-dihydro-1H-pyrrolo[1,2-a]benzimidazole etc. The imidazole compounds may be used not only as curing agents, but may be used also as accelerating admixture together with other curing agents.

The above-described hydrazide compounds include, for example, 1,3-bis(hydrazinocarboethyl)-5-isopropylhydantoin, 7,11-octadecadiene-1,18-dicarbohydrazide, eicosanoic diacid dihydrazide, adipic acid dihydrazide, etc.

The above-described melamine compounds include, for example, 2,4-diamino-6-vinyl-1,3,5-triazine, etc.

The above-described acid anhydrides include, for example, phthalic anhydride, trimellitic anhydride, pyromellitic anhydride, benzophenone tetracarboxylic anhydride, ethylene glycol bisanhydrotrimellitate, glycerol tris anhydrotrimellitate, methyl cyclohexene-dicarboxylic anhydride, tetrahydro phthalic anhydride, nadic acid anhydride, methyl nadic acid anhydride, trialkyl tetrahydro phthalic anhydride, hexahydro phthalic anhydride, methyl hexahydro phthalic anhydride, 5-(2,5-dioxo tetrahydro furil)-3-methyl-3-cyclohexene-1,2-dicarboxylic anhydride, trialkyl tetrahydro phthalic anhydride-maleic anhydride adducts, dodecenyl succinic anhydride, polyazelaic anhydride, polydodecanedioic anhydride, chlorendic anhydride etc.

The above-described heat latent cationic polymerization catalysts is not in particular limited, and, for example, ionic heat latent cationic polymerization catalysts such as benzylsulfonium salts, benzylammonium salts, benzyl pyridinium salts, Zenjiru sulfonium salts, etc. having antimony hexa fluoride, phosphorus hexa fluoride, boron tetra fluoride, etc. as a counter anion; nonionic heat latenty cationic polymerization catalysts, such as N-benzylphthalimide, aromatic sulfonic acid esters, etc. may be used.

The above-described optical latent cationic polymerization catalysts is not in particular limited, and examples include, for example, ionic optical latent cationic polymerization initiators such as onium salts such as aromatic diazonium salts, aromatic halonium salts, and aromatic sulfonium salts having hexafluoro antimony, hexafluoro phosphorus, tetrafluoro boron, etc. as a counter anion, and organometallic complexes such as iron-allene complexes, titanocene complexes, and aryl silanol aluminium complexes; and nonionic optical latent cationic polymerization initiators such as nitrobenzyl esters, sulfonic acid derivatives, phosphoric esters, phenolsulfonic acid esters, diazonaphthoquinone, and N-hydroxy imidosulfonate.

When the above-described curing agent has a phenol group, heat-resisting property, low water absorption property, and dimensional stability can be improved.

The above-described phenolic compounds having a phenol group include, for example, phenol novolak, o-cresolnovolak, p-cresolnovolak, t-butylphenol novolak, dicyclopentadiene cresol, phenol aralkyl resins, etc. Derivatives of the phenolic compounds may also be used, and the phenolic compounds may be used independently and two or more kinds may be used in combination.

When the above-described curing agent is a phenolic compound, the roughening treatment after curing of the resin composition makes much finer the surface roughness (Ra, Rz) of the cured body. When the above-described curing agent is a phenolic compound illustrated by either of following formulas (1) to (3), the surface roughness (Ra, Rz) of the cured body will be much finer. Furthermore, when the above-described curing agent is a phenolic compound, heat-resistance will be improved and water absorptivity will be lower. Moreover, the dimensional stability in the case of exposure to heat of the cured body improves further.

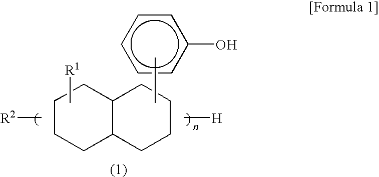

In the formula (1), R¹ represents methyl group or ethyl group, R² represents hydrogen or hydrocarbon group, and n represents an integer of 2 to 4.

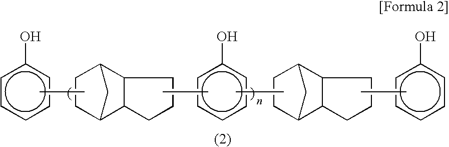

In the formula (2), n represents an integer of 0 or 1 to 5.

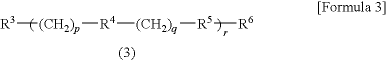

In the formula (3), R³ represents a group given with following formula (4a) or following formula (4b), R⁴ represents a group given with following formula (5a), following formula (5b), or following formula (5c), R⁵ represents a group given with following formula (6a) or following formula (6b), R⁶ represents hydrogen, or a chain group containing carbon atom of carbon number 1 to 20, p and q represent integers of 1 to 6, respectively, and r represents an integer of 1 to 11.

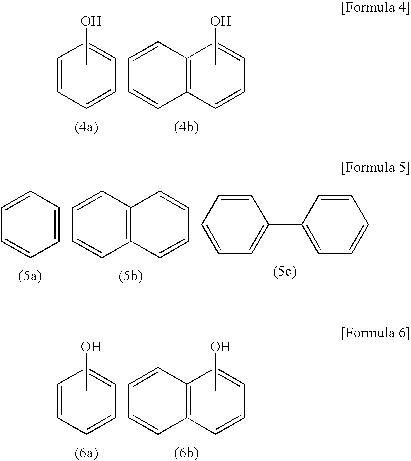

When the curing agent represented by the above-described formula (3) is a phenolic compound in which R⁴ has a biphenyl structure represented by the above-described formula (5c), the cured body has various excellent physical properties such as electrical property, a low coefficient of linear expansion, heat-resisting property, and low water absorption property. At the same time, the dimensional stability of the cured body in the case of exposure to heat further improves. In order to further improve such performances, compounds having a structure especially represented by following formula (7) are preferred.

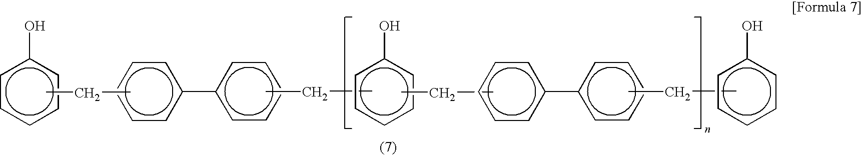

In the formula (7), n represents an integer of 1 to 11.

Aromatic polyvalent ester compounds, for example, may be mentioned as the above-described active ester compounds. It is described that since active ester groups do not form OH groups upon reaction with epoxy resins, they can provide a cured body having an excellent dielectric constant and a dielectric loss tangent, for example, in Japanese Patent Application Laid-Open No. 2002-12650. As an example marketed, for example, a product under the trade name of “EPICLON EXB9451-65T” manufactured by Dainippon Ink & Chemicals, Inc., etc. may be mentioned. Aliphatic benzoxazine or aromatic benzoxazine resins may be mentioned as the above-described benzoxazine compounds. As an example marketed, for example, a product under the trade name of “P-d type benzoxazine”, “F-a type benzoxazine” manufactured by SHIKOKU CHEMICALS CORPORATION may be mentioned. Furthermore, in addition to the above-mentioned imidazole compounds, accelerating agents such as phosphine compounds such as triphenyl phosphine, may be added into the resin composition.

The resin composition preferably includes biphenyl type epoxy resins as the epoxy resin, and any one of phenolic curing agents having biphenyl structure and active ester curing agents, and compounds including benzoxazine structure as a curing agent. The resin composition includes biphenyl type epoxy resins as the epoxy resin, and especially preferably includes a biphenyl type epoxy resin, and both of a phenolic curing agent having a biphenyl structure and an active ester curing agent. In this case, the epoxy and/or the curing agent have a biphenyl structure or an active ester structure, and therefore the resin itself cannot easily be affected, for example, in swelling and roughening processing as pretreatment of metal plating. Accordingly, roughening treatment after curing of the resin composition does not allow roughening of the surface of the resin, but allows selective removal of the silica treated with an imidazole silane having a mean particle diameter of not more than 5 micrometers, leading to formation of pores. Thereby, uneven surface having very small surface roughness on the surface of the cured body may be formed.

When the epoxy resin and/or the curing agent have a large molecular weight, they easily form a fine rough surface on the surface of the cured body, and therefore the weight average molecular weight of the epoxy resin is preferably not less than 4000, and the weight average molecular weight of the curing agent is preferably not less than 1800.

Furthermore, a larger epoxy equivalent amount of the epoxy resin and/or the equivalent amount of the curing agent tend to form fine rough surface on the surface of the cured body.

When the epoxy and/or the phenol curing agents have a biphenyl structure, the cured body obtained by curing of the resin composition has excellent electrical property, especially dielectric loss tangent, and it further has an excellent strength and a coefficient of linear expansion, leading to lower water absorption. When the curing agent has an aromatic polyvalent ester structure or a benzoxazine structure, the cured body having further excellent dielectric constant and dielectric loss tangent may be obtained.

The above-described biphenyl type epoxy resins include compounds obtained by substitution of a part of hydroxyl groups of phenolic compounds having hydrophobicity of the above-described formulas (1) to (7) by a group including epoxy groups, and by further substitution of the remaining groups by substituents other than the hydroxyl group, for example, a hydrogen atom. Furthermore, biphenyl type epoxy resins represented by following formula (8) may preferably be used.

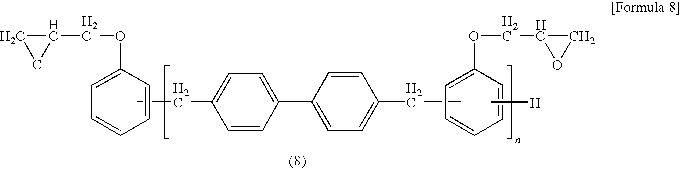

Referential notation n represents an integer of 1 to 11 in the above-described formula (8).

(Silica Treated with an Imidazole Silane)

The resin composition of the present invention includes a silica treated with imidazole silane processing and the silica has a mean particle diameter of not more than 5 micrometers.

The mixing proportion, in the resin composition, of the silica treated with imidazole silane processing is 0.1 to 80 parts by weight with respect to the mixture consisting of the epoxy resin and the curing agent 100 parts by weight. The mixing proportion of the silica is preferably in a range of 2 to 60 parts by weight with respect to the above-described mixture, and more preferably in a range of 10 to 50 parts by weight. The amount of the silica less than 0.1 parts by weight decreases the whole surface of the pores formed by removal of the silica by roughening treatment, etc., and therefore, may not exhibit a sufficient adhesive strength of metal plating. The amount smaller than 10 parts by weight reduces the improving effect of coefficient of linear expansion. The amount more than 80 parts by weight tends to make resin brittle.

As the above-described imidazole silanes, silane coupling agents having an imidazole group may suitably be used, and they are disclosed in Japanese Patent Application Laid-Open No. 09-169871 official report, Japanese Patent Application Laid-Open No. 2001-187836 official report, Japanese Patent Application Laid-Open No. 2002-128872 official report, etc.

The above-described silica include crystalline silica obtained by grinding; crushed fused silica obtained by flame fusion and grinding; spherical fused silica obtained by flame fusion, grinding, and flame fusion; fumed silica (Aerosil); and synthetic silica etc. obtained by sol gel process silica, etc., using natural silica as raw materials. Since the synthetic silica includes ionic impurities in many cases, the fused silica is preferably used in respect of purity.

As the shape of the silica, for example, spherical shape, unfixed shape, etc. may be mentioned. In order to provide easier removal of the silica in roughening treatment to the cured body of the resin, the silica preferably has a spherical shape.

In order to obtain finer rough surface, the silica having a mean particle diameter of not more than 5 micrometers is used for the present invention. In the roughening treatment of the cured body of the resin, a mean particle diameter larger than 5 micrometers does not allow easy removal of the silica, but enlarges the pore size formed after the silica has removed, leading to coarser surface roughness. When the epoxy resin and the curing agent especially have phenol and biphenyl structure or aromatic polyvalent ester structure, benzoxazine structure, etc. that may not allow easy processing in roughening treatment, etc., the larger particle diameter of the silica makes removal difficult.

The mean particle diameter of the silica is preferably not more than 1 micrometer. In the roughening treatment for the cured body of the resin, a mean particle diameter of not more than 1 micrometer allows much easier removal of the silica, and further provides much finer pores formed in the surface of the cured body after removal. As the mean particle diameter of the silica, a value of a median diameter (d50) that gives 50% is employable, and this value may be measured with a size distribution measuring device in a laser diffraction dispersion method.

In the present invention, a plurality of silica having mutually different mean particle diameters may be used together.

The maximum particle diameter of the silica is preferably not more than 5 micrometers. In the roughening treatment to the resin composition, the maximum particle diameter not more than 5 micrometers allows much easier removal of the silica, and, moreover, it does not allow the formation of comparatively coarser unevenness on the cured body surface, leading to formation of uniform and fine unevenness. When the epoxy resin and the curing agent especially have biphenyl structure or aromatic polyvalent ester structure, benzoxazine structure, etc. that may not allow easy processing in roughening treatment, etc., permeation of roughening solution from the surface of the cured body may not take place easily, and the maximum particle diameter of the silica not more than 5 micrometers allows easy removal of the silica.

The specific surface area of the silica is preferably not less than 3 m²/g. For example, when metal plating layers such as made of copper, etc. are formed on the surface of the cured body, the specific surface area less than 3 m²/g may not provide sufficient adhesive property of the cured body and the metal plating, but may give the possible reduction of mechanical property. The specific surface area may be determined by the BET method.

The following methods are mentioned as a method of treating the silica with imidazole silanes.

A method called a dry process is mentioned as the method, and a method of direct attaching of a silane compound to the silica may be mentioned as an example. In detail in the method, after supply of a silica into a mixer, a solution of an alcohol or water of an imidazole silane is dripped or sprayed accompanied by agitation, and after further agitation, classification is carried out with a sieve. Furthermore, after dehydration condensation of the silane compound and the silica by heating, a silica treated with the imidazole silane may be obtained.

A method called a wet method is mentioned as another method. As one example, an imidazole silane is added with agitation of a silica slurry, and after further agitation, filtration, drying, classification with a sieve is performed. Furthermore, after dehydration condensation of the silane compound and the silica by heating, a silica treated with the imidazole silane may be obtained.

Since the silica is compounded with the epoxy resin by curing of the resin composition, use of the silica treated with an imidazole silane can improve the glass transition temperature Tg of the cured body by 10 to 15 degrees C. as compared with a case of use of an untreated silica. That is, instead of the inclusion of the untreated silica in the resin composition, inclusion of the silica treated with the imidazole silane in the resin composition can provide the cured body having a high glass transition temperature Tg.

### (Organized Layered-Silicate)

The resin composition of the present invention preferably includes an organized layered-silicate.

The inclusion of the organized layered-silicate and the above-described silica treated with the imidazole silane in the resin composition will allow the existence of the organized layered-silicate in the circumference of the silica. In this case, after heated-curing of the resin composition, for example, further swelling and roughening processing given thereto can allow much easier removal of the silica treated with the imidazole silane that exists on the surface of the cured body of the resin. Although the mechanism of easy removal of the silica is not yet clarified, the reason is probably because that a swelling liquid or a roughening solution permeates into a plurality of interfaces in a nano order between layers of the organized layered-silicate or between the organized layered-silicate and the resin, and at the same time that the liquid of the solution also permeate into the interface between the epoxy resin and the silica treated with the imidazole silane.

The mixing proportion of the organized layered-silicate in the resin composition is preferably in a range of 0.01 to 50 parts by weight to a mixture consisting of the epoxy resin and the curing agent 100 parts by weight. The organized layered-silicates less than 0.01 parts by weight may not sufficiently exhibit the improvement effect of removal of the silica by blending of the organized layered-silicate. The organized layered-silicates more than 50 parts by weight may exhibit thixotropic property very much, and may deteriorate handling property.

The organized layered-silicate in the specification represents layered-silicates with the publicly known organized processings given thereto for the purpose of improvement in dispersibility in resins, and cleavability.

The layered-silicate represents stratified silicates having exchangeable metallic cation between layers thereof, and it may be a natural product and may be a synthesized product.

Use of layered-silicates having a large aspect ratio as the layered-silicate may improve the mechanical property of the resin composition.

Layered-silicates having a large aspect ratio, for example, include smectite based clay minerals, swelling mica, vermiculite, halloysite, etc. The smectite based clay minerals include montmorillonite, hectorite, saponite, beidellite, stevensite, nontronite, etc.

At least one kind selected from a group consisting of montmorillonite, hectorite, and swelling mica among them is used suitably as the layered-silicate. These layered-silicates may be used independently and two or more kinds may be used in combination.

The organized layered-silicate is preferably uniformly dispersed in the epoxy resin, and a part or all of the organized layered-silicate is more preferably dispersed in the epoxy resin with number of layers making not more than 5 layers. The uniform dispersion of the organized layered-silicate in the epoxy resin, or dispersion of a part or all of the organized layered-silicates with number of layers making not more than 5 layers in the epoxy resin can increase the interfacial area between the epoxy resin and the organized layered-silicate. Furthermore, in order to improve the mechanical strength of the cured body, the proportion of the organized layered-silicate currently dispersed with number of layers making not more than 5 layers in the epoxy resin is preferably not less than 10% out of the whole organized layered-silicate currently dispersed in the epoxy resin, and more preferably is not less than 20%.

The mixing proportion of the organized layered-silicate may suitably be determined according to applications of the resin composition.

For example, in the case of use for sealing agent of the resin composition, the mixing proportion of the organized layered-silicate is preferably in a range of 0.01 to 50 parts by weight with respect to the mixture consisting of the epoxy resin and the curing agent 100 parts by weight, and more preferably in a range of 0.1 to 40 parts by weight. The mixing proportion less than 0.1 parts by weight increases a coefficient of linear expansion, and the mixing proportion exceeding 40 parts by weight raises the viscosity of the resin composition, or lowers dispersibility.

Furthermore, for example in use of the resin composition for a printed circuit board application, the mixing proportion of the organized layered-silicate is preferably in a range of 0.1 to 30 parts by weight with respect to the mixture consisting of the epoxy resin and the curing agent 100 parts by weight, and more preferably in a range of 0.3 to 5 parts by weight. The mixing proportions less than 0.1 parts by weight raises the coefficient of linear expansion, and the mixing proportion exceeding 30 parts by weight deteriorates perforation workability, especially perforation workability with a laser. The silica treated with the imidazole silane and the organized layered-silicate are blended in a range of 0.11 to 130 parts by weight as a total with respect to the above-described mixture 100 parts by weight, and more preferably in a range of 5 to 50 parts by weight. The mixing ratio of the silica treated with the imidazole silane and the organized layered-silicate is 1:0.05 to 1:0.5. The lower proportion of the organized layered-silicate may not provide an easy improvement effect of removal of the silica treated with the imidazole silane, and the larger proportion of the organized layered-silicate makes formation of a fine rough surface difficult.

The diameter of the organized layered-silicate may be measured by the cross-section observation of the resin composition by an electron microscope, etc.

### (Other Components)

Unless achievement of objectives of the present invention is impeded, additives such as thermoplastic resins, thermoplastic elastomers, cross linked rubbers, oligomers, inorganic compounds, nucleating agents, antioxidants, antistaling agents, thermostabilizers, light stabilizers, ultraviolet absorbers, lubricants, fire-resistant auxiliary agents, antistatic agents, antifoggers, fillers, softeners, plasticizers, and colorants, may be blended, if needed, to the resin composition of the present invention. These may be used independently and two or more kinds may be used in combination.

For example, at least one kind of thermoplastic resins selected from a group consisting of polysulphone resins, polyether sulphone resins, polyimide resins, and polyetherimide resins; and at least one kind of thermosetting resins selected from a group consisting of polyvinyl benzyl ether resins and a reaction product by a reaction of a difunctional polyphenylene ether oligomer and a chloromethylstyrene (trade name of “OPE-2St” manufactured by Mitsubishi Gas Chemicals) may be added to the resin composition. These thermoplastic resins and thermosetting resins may be used independently, and two or more kinds may be used in combination. The mixing proportion of the thermoplastic resin in the resin composition is preferably in a range of 0.5 to 50 parts by weight with respect to the epoxy resin 100 parts by weight, and more preferably in a range of 1 to 20 parts by weight. The thermoplastic resins less than 0.5 parts by weight may not allow sufficient improvement in an elongation or a toughness value, and an amount larger than 50 parts by weight may lower the strength.

### (Resin Composition)

The method for producing the resin composition of the present invention is not in particular limited, and for example, a method may be mentioned in which after addition to a solvent of a mixture of the epoxy resin and the curing agent, the silica treated with an imidazole silane, and, if necessary, the organized layered-silicate, the solvent is removed by drying.

The prepreg of the present invention is formed by impregnation of the resin composition into a porous base material. The material of the porous base material is not especially limited as long as it is a material that allows impregnation of the resin composition, and organic fibers such as carbon fibers, polyamide fibers, polyaramid fibers, and polyester fibers, glass fibers, etc. may be mentioned. Furthermore, the shapes of the fibers include textiles such as plain woven fabrics and twill fabrics, nonwoven fabrics, etc., and glass fiber nonwoven fabric are especially preferred.

A cured body may be obtained by heated-curing of the resin composition or a prepreg obtained by impregnation of the resin composition of the present invention. The cured body represents a product in a range from a cured body having a light-cured state generally called B-stage to a cured body having a full-cured state.

For example, the cured body of the present invention may be obtained in the following manner.

When the resin composition is heated at 160 degrees C. for 30 minutes, a certain light-cured body will be obtained in the course of the reaction. When this light-cured body is further heated at a high temperature, for example at 180 degrees C., and for 1 to 2 hours, a nearly full-cured body will be obtained.

In order to form fine unevenness on the surface of the obtained cured body of the resin, for example, roughening treatment, or swelling treatment and roughening treatment is performed.

As the swelling treatment, for example, a treatment method with an aqueous solution, a dispersed solution in an organic solvent, etc. including a compound such as ethylene glycol, etc. as a principal component is used. In more detail, the cured body of the resin is treated for 1 to 20 minutes at a treatment temperature of 30 to 85 degrees C., for example, using an aqueous solution of 40% by weight of ethylene glycol, etc., in the swelling treatment.

In the roughening treatment, for example, chemical oxidizing agents having manganese compounds such as potassium permanganate and sodium permanganate; chromium compounds such as potassium dichromate and chromic anhydride potassium; persulfuric acid compounds such as sodium persulfate, potassium persulfate, and ammonium persulfate, as a principal component, etc. are used. These chemical oxidizing agents may be used, for example, in a shape of an aqueous solution or dispersed solution in an organic solvent. The roughening treatment method is not especially limited, and, for example, preferably performed is 1 or 2 times of treatment of the cured body using a solution of permanganic acid or permanganate of 30 to 90 g/L, and a solution of sodium hydroxide of 30 to 90 g/L, at a treatment temperature of 30 to 85 degrees C. for 1 to 10 minutes. Although many times of processing exhibits larger roughening effect, the repeated processing removes the surface of resin away. Not less than 3 times of the roughening treatment may not substantially vary the roughening effect for an increased number of times of the processing, or may sometimes not form clear unevenness on the surface of the cured body.

The cured body obtained by the above described processings has a surface roughness Ra not more than 0.2 micrometers, and has a surface roughness Rz not more than 2.0 micrometers. When a mean diameter of the silica treated with an imidazole silane is not more than 1 micrometer, the cured body has a plurality of pores having a mean diameter of not more than 5 micrometers, a surface roughness Ra not more than 0.15 micrometers, and a surface roughness Rz not more than 1.5 micrometers. When a plurality of pores has a mean diameter larger than 5 micrometers, there is shown a tendency of an easy short circuit for wirings using smaller L/S, leading to difficulty of formation of finer circuits. On the contrary, a surface roughness Ra more than 0.2 micrometers fails in improvement in the speed of transmission rate of electrical information. Furthermore, a surface roughness Rz more than 2.0 micrometers also fails in improvement in the speed of the transmission rate of electrical information. The surface roughness Ra and Rz are determined by a measuring apparatus based on a measuring method of JIS B 0601-1994, etc.

After roughening treatment, the cured body may be treated with publicly known catalysts for metal plating or with nonelectrolytic plating, if needed, and then may be treated with electrolytic plating.

In the vicinity of the surface of the pores formed by removal of the silica, progress of the curing reaction with the imidazole will probably increase mechanical strength very much. Therefore, since the strength in the vicinity of the surface of the pores that exhibit anchoring effect are well maintained in addition to the dimensional anchoring effect, the metal plating treatment such as with copper can form a copper plating layer having intense adhesive property with the cured bodies having biphenyl structure, aromatic polyvalent ester structure, or benzoxazine structure that give possible difficulty in treatment by roughening treatment, etc.

The resin composition will be used in, for example, a form of a solution in a suitable solvent, or of a state of molded film. The application of the resin composition is not in particular limited, and may suitably be used, for example, as materials for substrates for formation of core layers, buildup layers, etc. of layered substrates; sheets, laminated substrates; copper foils with resins; copper clad laminated substrates; tapes for TAB; printed circuit boards; prepregs; varnishes, etc.

Since the roughening treatment after curing of the resin composition gives roughness smaller than conventional roughness to the surface formed by the roughening treatment, a larger thickness of an insulating layer may be provided in view of electrical property. Furthermore, a smaller surface roughness also makes it possible to make thickness of insulating layer thinner. Accordingly, the resin composition can form finer wirings in use in applications that need insulation as in copper foils with resin, copper clad laminated substrates, printed circuit boards, prepregs, adhesive sheets, tapes for TAB, etc., leading to resulting improved signal transmission speed. When using the resin composition of the present invention in build up substrates for formation of multiple resin layers and conductive metal plating layers by an additive process, a semi-additive process, etc. of formation of circuits after conductive metal plating, reliability of bonded interfaces of the conductive metal plating layer and the resin may preferably be improved.

Use of the resin composition will allow production with a high yield, even in case of production for materials for substrates, sheets, laminated substrates, copper foils with resin, copper clad laminated substrates, tapes for TAB, printed circuit boards, prepregs, or adhesive sheets through many process steps, leading to exhibition of improved adhesive property, electrical property, high temperature physical property, dimensional stability (low coefficient of linear expansion), and barrier property such as moisture resistance. In the specification, the sheet shall include sheets in a film state without self-standing-ability.

Methods for the above-described molding are not in particular limited, and include, for example, an extrusion method, in which materials are extruded after melt kneading by an extruder, and then are molded into a film state using T die, circular die, etc.; a casting molding method, in which after dissolution or dispersion of materials in a solvent such as an organic solvent, the materials are molded in a film state by casting; conventionally publicly known film molding methods, etc. Of these methods, the extrusion method and the casting molding method are suitably used, because a thinner formed body may be obtained in manufacturing multilayer printed boards using the resin sheet comprising the resin composition of the present invention.

The sheet-like formed body concerning the present invention is obtained by molding the resin composition, the prepreg, or the cured body into a shape of a sheet. The sheet-like formed body includes, for example, a sheet having a shape in a film state and an adhesive sheet.

The above-described sheet, laminated substrate, etc. may be laminated into a sheet, a laminated product, etc. that can be released from each other, for the purpose of assistance in conveyance, of prevention of contamination by dust or defect, etc. Examples of films having mold-releasing characteristics include resin coated papers, polyester films, polyethylene terephthalate (PET) films, polypropylene (PP) films, etc. Moreover, a mold-releasing treatment may be given to these films, if needed.

The mold-releasing treatment method includes: a method in which silicone compounds, fluorine compounds, surface active agents, etc. are added to the films; a satin embossing treatment method in which unevenness is applied to the surface of the film for exhibiting mold-release characteristic, etc.; a method in which materials having the mold-releasing characteristic of silicone compounds, fluorine compounds, surface active agents, etc. are applied to the surface, etc. In order to further protect the film having mold-releasing characteristics moreover, protective films such as resin coated papers, polyester films, PET films, and PP films, may be laminated onto the film.

When the organized layered-silicate is included in the resin composition, gas molecules spread bypassing the layered-silicate when diffusing in the epoxy resin and the curing agent for the epoxy resin, and therefore the cured body having also improved gas barrier property may be obtained. Similarly, barrier properties other than to the gas molecules are also improved, and solvent resistance may also be improved, or moisture absorptivity and water absorptivity may be lowered. Accordingly, the resin composition including the organized layered-silicate may advantageously be used, for example, in insulating layers in multilayer printed wiring board. Furthermore, use of the resin composition of the present invention can also suppress the migration of copper in the circuit including the copper. Occurrence faults caused by poor metal plating by bleed out, to the surface, of a very small amount of additives existing in the resin composition can also be suppressed.

In the case of the flexible epoxy resin having butadiene skeleton in which the epoxy resin comparatively tends to be attacked by roughening solutions, etc., the inclusion of the organized layered-silicate has an effect of suppressing the excessive growth of roughness of the surface by the roughening treatment. Although the mechanism is not yet clear, the addition of the organized layered-silicate suppresses permeation of the swelling liquid or the roughening solution into the cured body except in the vicinity of the surface, and probably thereby the resin itself has a tendency of avoiding excessive treatment.

Even when the resin composition does not include the so large amount of the organized layered-silicates, it exhibits the above-described excellent properties. Accordingly, a thinner insulating layer can be obtained as compared with insulating layers of conventional multi-layered printed boards, leading to thinner multi-layered printed boards with higher density. The dimensional stability of the cured body can be improved owing to nucleating effect of the layered-silicate in crystal formation, and the swelling suppression effect by improvement of moisture-proof property. For this reason, a stress caused by difference in dimension before and after thermal history can also be made smaller. Accordingly, use as an insulating layer in a multilayer printed board may effectively improve the reliability of electrical connection.

Furthermore, when the silica 0.1 to 80 parts by weight and the organized layered-silicate 0.01 to 50 parts by weight, to a mixture consisting of the epoxy resin and the curing agent 100 parts by weight, are blended into the resin composition, and when a perforation processing is given by a laser such as a carbon dioxide laser to a substrate molded into a sheet shape by curing of the resin composition of the present invention, the epoxy resin composition, the epoxy resin curing agent component, and the layered-silicate component are simultaneously decomposed and vaporized, leaving extremely small amount of partially residual components originated in resin components and inorganic substances. Accordingly, possibly remaining residues of the layered-silicate will easily be removed in desmear treatment without two or more times or two or more kinds of the treatment in combination. Therefore, occurrence of possible poor metal platings caused by residues generated by perforation may be suppressed. Publicly known methods, for example, a plasma treatment, and a chemical treatment may be used as the desmear treatment.

A metal layer, for example, as a circuit may be formed at least on one side of the resin composition, the prepreg, the cured body, and materials for the substrates comprising the materials, the sheet-like formed body, the laminated substrate, the copper foil with resin, the copper clad laminated substrate, the tape for TAB, the printed circuit board, the multilayered laminate, the adhesive sheet, etc.

The metals include metallic foils used for shielding, and circuit formation, metal platings, and materials for metal platings used for circuit protection. The metal plating materials include, for example, gold, silver, copper, rhodium, palladium, nickel, tin, etc. These may be alloys made of two or more kinds of the metals, and may be multilayered materials made of two or more kinds of metal plating materials. Furthermore, these may also include other metals and materials for improvement of physical properties.

Finer unevenness may be formed by a smaller mean particle diameter of the silica included in the resin composition. Accordingly, the resin composition including the silica having a smaller mean particle diameter can very advantageously speed signal processing in copper wirings with a smaller L/S. <<Mean particle diameter of silica is smaller.>> For example, when an L/S that represents a degree of fineness of wiring of a circuit is less than 65/65 micrometers or less than 45/45 micrometers, the mean particle diameter of the silica is preferably not more than 5 micrometers, and more preferably not more than 2 micrometers. When the L/S is less than 13/13 micrometers, the mean particle diameter of the silica is preferably not more than 2 micrometers, and more preferably not more than 1 micrometer.

The resin composition obtained according to the present invention is applicable to materials for sealings, solder resists, etc.

Hereinafter, more detailed description of the present invention will be given, with reference to detailed examples and comparative examples of the present invention.

### EXAMPLE, COMPARATIVE EXAMPLE

Raw materials shown below were used in the examples and comparative examples.

### 1. Epoxy Resin

Biphenyl based epoxy resin (1) (trade name “NC-3000H”, weight average molecular weight 2070, epoxy equivalent amount 288, manufactured by Nippon Kayaku Co., Ltd.) (represented by the formula (8))

Biphenyl based epoxy resin (2) (trade name “YX4000H”, manufactured by Japan Epoxy Resins Co., Ltd.)

Biphenyl based epoxy resin (3) (trade name “YL6640” manufactured by Japan Epoxy Resins Co., Ltd.)

Bisphenol A type epoxy resin (Trade name “YD-8125”, weight average molecular weight approximately 350, manufactured by Tohto Kasei Co., Ltd.)

Bisphenol F type epoxy resin (Trade name “RE-304S,” manufactured by Nippon Kayaku Co., Ltd.)

DCPD based resin (Trade name “EXA7200HH,” manufactured by DAINIPPON INK AND CHEMICALS, INCORPORATED)

### 2. Epoxy Resin Curing Agent

Phenolic curing agent (1) consisting of hydrophobic phenolic compound represented by the aforementioned formula (7), (Trade name “MEH7851-4H”) weight average molecular weight 10200 in terms of Pst, manufactured by MEIWA PLASTIC INDUSTRUIES, LTD.)

Phenolic curing agent (2) consisting of hydrophobic phenolic compound represented by the aforementioned formula (7), (Trade name “MEH7851-H”, weight average molecular weight 1600 in terms of Pst, manufactured by MEIWA PLASTIC INDUSTRUIES, LTD.)

Dicyandiamide (trade name “EH-3636S”, manufactured by Asahi Denka Kogyo K. K.)

Active ester compound type curing agent (Trade name “EXB-9451-65T”, weight average molecular weight 2840 in terms of Pst, manufactured by DAINIPPON INK AND CHEMICALS, INCORPORATED)

Benzoxazine resin (trade name “P-d type benzoxazine”, manufactured by Shikoku Chemicals Corp.)

### 3. Organized Layered-Silicate

Synthetic hectorite with chemical treatment by trioctyl methylammonium salt (Trade name “Lucentite STN”, manufactured by CO—OP CHEMICAL CO., LTD.)

### 4. Organic Solvent

N,N-dimethylformamide (DMF, highest quality, manufactured by Wako Pure Chemical Industries, Ltd.)

### 5. Curing Accelerating Agent

Triphenyl phosphine (manufactured by Wako Pure Chemical Industries, Ltd.)

Imidazole (trade name “2 MAOK-PW,” manufactured by Shikoku Chemicals Corp.)

### 6. Silica

Silica (trade name “1-Fx”, manufactured by Tatsumori LTD.) average particle diameter of 0.38 micrometers, maximum particle diameter of 1 micrometer, and surface area of 30 m²/g

Silica (trade name B-21, manufactured by Tatsumori LTD.), average particle diameter of 1.5 micrometers, maximum particle diameter of 10 micrometers, and specific surface area 5 m²/g

Silica (trade name “FB-8S”, manufactured by DENKI KAGAKU KOGYO K. K.), average particle diameter of 6.5 micrometers, and specific surface area of 2.3 m²/g

### 7. Silica Surface Treating Agent

Imidazole silane (trade name “IM-1000,” manufactured by Nikko Materials)

Epoxysilane (trade name “KBM-403,” manufactured by Shin-etsu chemical Co., Ltd.)

Vinylsilane (trade name “KBM-1003”, manufactured by Shin-etsu chemical Co., Ltd.)

### (Imidazole Silane Treatment Method of Silica)

Silica 100 parts by weight, imidazole silane 0.2 parts by weight, and ethanol 100 parts by weight were mixed, and after 1 hour of agitation at 60 degrees C., the volatile components were evaporated off. Then, the resulting product was dried at 100 degrees C. with vacuum dryer for 6 hours to give the silica (1) as a filler treated with the imidazole silane.

The same treatment was performed except for having used the epoxysilane instead of the imidazole silane in the above-described method to give the silica (2) as a filler treated with the imidazole silane.

The same treatment was performed except for having used the vinylsilane instead of the imidazole silane in the above-described method to give the silica (3) as a filler treated with the imidazole silane.

### Example 1

Synthetic hectorite “Lucentite STN” 0.61 g and DMF 49.8 g were mixed, and agitated at an ordinary temperature to give a completely uniform solution. Subsequently, triphenyl phosphine 0.03 g was added, and the solution was agitated at an ordinary temperature to give a completely uniform solution. Then the silica “1-Fx” with the surface treatment by imidazole silane “IM-1000” given thereto was added and the solution was agitated at an ordinary temperature to give a completely uniform solution. The biphenyl type epoxy resin “NC-3000H” 15.71 g was added and the solution was agitated at an ordinary temperature to give a completely uniform solution. In the next step, the epoxy resin curing agent “MEH7851-4H” 13.77 g comprising a hydrophobic phenolic compound was added to the above-described solution, and the solution was agitated at an ordinary temperature until it gave a completely uniform solution. In this way, a resin composition solution was prepared.

The obtained resin composition solution was applied using an applicator on a transparent polyethylene terephthalate (PET) film with a mold-releasing treatment given thereto (trade name “PET5011 550”, thickness 50 micrometers, manufactured by Lintec Corporation) to give a thickness after drying of 50 micrometers. The resultant film was dried for 12 minutes in a gear oven at 100 degrees C. to obtain a non-cured body of the resin sheet with a dimension of 200 mm×200 mm×50 micrometers. Subsequently, this non-cured body of the resin sheet was heated in a gear oven at 170 degrees C. for 1 hour to obtain a light-cured body of the resin sheet.

### Examples 2 to 11 and Comparative Examples 1 to 6

The same method as the method of Example 1 was repeated except for having used resin composition solutions with blending compositions shown in Tables 1 and 2 to prepare resin composition solutions, and then non-cured bodies and light-cured bodies of the resin sheets were further manufactured.

### Examples 12 to 20 and Comparative Examples 7 to 12

The same method as the method of Example 1 was repeated except for having used resin composition solutions having blending compositions shown in Tables 3 and 4 to prepare resin composition solutions, and then non-cured bodies and light-cured bodies of the resin sheets were further manufactured.

### Examples 21 to 29 and Comparative Examples 13 to 21

The same method as the method of Example 1 was repeated except for having used resin composition solutions having blending compositions shown in Tables 5 and 6 to prepare resin composition solutions, and then non-cured bodies and light-cured bodies of the resin sheets were further manufactured. Following Table 7 describes symbols shown in Table 1 to Table 6.

(Copper Plating Treatment Using the Non-Cured Bodies in Examples 1 to 29 and Comparative examples 1 to 21)

Each of the non-cured bodies of the resin sheets obtained as described above was laminated in a vacuum condition onto a glass epoxy board (FR-4, lot number “CS-3665,” manufactured by RISHO KOGYO CO., LTD.) Onto the surface of the substrates after curing for 30 minutes at 170 degrees C., a) swelling treatment, then, b) permanganate treatment, i.e., roughening treatment and further c) copper plating treatment described later were given. The roughening treatment was not performed in Comparative examples 6, 12, and 18.

### a) Swelling Treatment

The glass epoxy board having the resin sheet laminated thereonto under vacuum was immersed into a swelling liquid (Swelling Dip Securigant P, manufactured by Atotech Japan) at 80 degrees C., and subsequently, the board was washed well with pure water.

### b) Permanganate Treatment

The glass epoxy board having the resin sheet laminated thereonto under vacuum was immersed into a roughening aqueous solution of potassium permanganate (Concentrate Compact CP, manufactured by Atotech Japan) at 80 degrees C., and then oscillation treatment was performed for 20 minutes. After completion of the roughening treatment by the permanganate, the resin sheet was treated with a washing liquid (Reduction Securigant P, manufactured by Atotech Japan) for 2 minutes at 25 degrees C., and subsequently, the board was washed well with pure water.

### c) Copper Plating Treatment

The resin sheet that has been laminated under vacuum on the glass epoxy board and that has been given the above-described roughening treatment was treated with nonelectrolytic copper plating and an electrolytic copper plating treatment in the following manner. The resin sheet was treated with an alkaline cleaner (Cleaner Securigant 902) at 60 degrees C. for 5 minutes, and the surface thereof was degreased and washed. The above-described resin sheet was treated with a pre-dip liquid (Pre-dip Neogant B) after washing at 25 degrees C. for 2 minutes. Subsequently, the above-described resin sheet was treated with an activator liquid (Activator Neogant 834) at 40 degrees C. for 5 minutes to be provided with a Palladium catalyst. The above-described resin sheet was next treated with a reduction liquid (Reducer Neogant WA) at 30 degrees C. for 5 minutes.

The above-described resin sheet was introduced into a chemically Cu-enriched liquid (Basic Printgant MSK-DK, Copper Printgant MSK, Stabilizer Printgant MSK) to perform a nonelectrolytic plating until the metal plating thickness gave about 0.5 micrometers of thickness. Annealing was performed for 30 minutes at a temperature of 120 degrees C. after nonelectrolytic plating for elimination of residual hydrogen gas. In all the processes from the start of treatment to the nonelectrolytic plating, 1 L of the treating solution was used in a beaker scale, and each process was carried out being accompanied by oscillation of the resin sheet.

Next, electrolytic plating was given to the resin sheet after vacuum lamination and nonelectrolytic plating treatment on the glass epoxy board, until the thickness of the plating gave 25 micrometers. Copper sulfate (Reducer Cu) was used for electrolytic copper plating, and 0.6 A/cm² of electric current was used. Heated-curing was performed at 180 degrees C. after copper plating treatment for 1 hour.

### (Manufacture of Cured Body)

Furthermore, the light-cured bodies obtained in Examples 1 to 29 and Comparative examples 1 to 21 were heated by curing conditions separately shown in Table 1 to Table 6 to obtain the cured bodies.

### (Evaluation of Resin Compositions Obtained in Examples and Comparative Examples)

The physical properties and the surface state after roughening treatment of the light-cured bodies of the resin sheets, and the cured bodies of the resin sheets obtained in Examples 1 to 29 and Comparative examples 1 to 21 were evaluated for by the following methods.

Evaluated items include:

### 1. Dielectric Constant,

### 2. Dielectric Loss Tangent,

### 3. Average Linear Expansion Coefficient,

### 4. Glass Transition Temperature (Tg),

### 5. Tensile Strength,

### 6. Tensile Elongation

### 7. Roughened Adhesive Strength,

### 8. Surface Roughness (Ra, Rz), and

### 9. Adhesive Strength of Copper.

For the cured body, measured for were:

### 1. Dielectric Constant,

### 2. Dielectric Loss Tangent,

### 3. Average Linear Expansion Coefficient,

### 4. Glass Transition Temperature,

### 5. Tensile Strength, and

### 6. Tensile Elongation.

During the above-described copper plating treatment, the non-cured body laminated under vacuum onto the glass epoxy board was heated to be cured into a light-cured state, and then the swelling treatment and the roughening treatment were given in a) Swelling treatment, b) Roughening treatment by permanganate, and c) Copper plating treatment. Subsequently, the treated resin was evaluated for 8: Surface roughness, and then also evaluated for 7: Roughening Adhesive Strength and 9: Adhesive Strength of Copper after copper plating treatment. Detailed results will be shown hereinafter.

### (Evaluation Item and Evaluation Method)

### 1. Dielectric Constant and 2. Dielectric Loss Tangent

The cured body of the resin sheet was cut into a size of 15 mm×15 mm, and then 8 sheets thereof were layered together to obtain a laminated product having a thickness of 400 micrometers. The obtained laminated product was measured for a dielectric constant and a dielectric loss tangent at a frequency of 1 GHz at an ordinary temperature using a dielectric constant measuring device (type number “H.P.4291B”, product made by Hewlett-Packard Development Company, L. P.)

### 3. Average Linear Expansion Coefficient

The cured body of the resin sheet was cut into a size of 3 mm×25 mm, and then the cured body was measured for an average linear expansion coefficient (α1) in a range from 23 to 100 degrees C. and an average linear expansion coefficient (α2) in a range from 23 to 150 degrees C. under conditions of a tensile load 2.94×10⁻² N and heating rate of 5 degrees C./minute using a coefficient of linear expansion measuring device (type number “TMA/SS 120C”, produced by Seiko Instruments Inc.)

### 4. Glass Transition Temperature (Tg)

The cured body of the resin sheet was cut into a size of 5 mm×3 mm, and the cured body was measured for a temperature giving a maximum of a loss factor tan δ (glass transition temperature Tg) under conditions of a heating rate of 5 degrees C./minute from 30 to 250 degrees C. using a visco-elasticity spectro-rheometer (type number “RSA-II” produced by Rheometric Scientific F. E.)

### 5. Tensile Strength, 6. Tensile Elongation

The cured body (100 micrometers in thickness) of the resin sheet cut into a size of 10×80 mm, a tensile test was performed under conditions of a distance between chucks of 60 mm, and a crosshead speed of 5 mm/minute using a tensile testing measuring device (trade name “Tensilon” produced by ORIENTEC Co., LTD.), and thus the cured body was measured for a tensile strength (Mpa) and a tensile elongation (%).

### 7. Roughened Adhesive Strength

The non-cured body of the resin sheet was laminated under vacuum onto a glass epoxy board (FR-4 and type number “CS-3665” manufactured by RISHO KOGYO CO., LTD.) After heat-treatment for 30 minutes at 170 degrees C., the above-described swelling treatment and roughening treatment by permanganate were given to the substrate, and then the chemical copper plating and the electrolytic copper plating were performed thereonto. Cuts were given with a width of 10 mm on the surface of the copper plating layer of the substrate after 1 hour of heated-curing at 180 degrees C. Measuring was performed under a condition of 5 mm/minute in crosshead speed using a tensile testing machine (trade name “Autograph”, produced by Shimadzu Corp.), and the copper plating layer of the substrate was measured for a roughened adhesive strength.

### 8. Surface Roughness (Ra, Rz)

The sheet of the light-cured body was laminated under vacuum onto a glass epoxy board (FR-4 and type number “CS-3665” manufactured by RISHO KOGYO CO., LTD.) The above-described swelling treatment and roughening treatment by the permanganate were given to the substrate after heat-treatment for 30 minutes at 170 degrees C. Using a scanning laser microscope (type number “1LM21”, produced by Lasertec Corporation), the surface of the resin was measured for a surface roughness (Ra, Rz) in a test area of 100 square micrometers.

### 9. Adhesive Strength of Copper

The light-cured body of the resin sheet was laminated under vacuum onto CZ-treated copper foil (CZ-8301, manufactured by MEC CO., LTD.), and then a heat-treatment was given at 180 degrees C. for 1 hour. Cuts were given by a width of 10 mm on the surface of the copper foil. Measurement was performed under conditions of 5 mm/minute in crosshead speed, using a tensile testing machine (trade name “Autograph”, produced by Shimadzu Corp.), and thus the copper foil was measured for an adhesive strength of copper.

Following Tables 1 to 6 show the results. Descriptions of the symbols of Table 1 to Table 6 will be shown in Table 7.

TABLE 1

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Epoxy Resin | Biphenyl Based | A1 | 15.71 | 15.71 | 10.15 | | | 9.43 | 9.43 | 12.57 | 15.71 | 15.71 | 15.71 |
| | Epoxy Resin (1) | | | | | | | | | | | | |
| | Biphenyl Based | A2 | | | | | | 4.43 | | | | | |
| | Epoxy Resin (2) | | | | | | | | | | | | |
| | Biphenyl Based | A3 | | | | | | | 4.41 | | | | |
| | Epoxy Resin (3) | | | | | | | | | | | | |
| | Bisphenol A Type | A4 | | | | 10.00 | | | | | | | |
| | Epoxy Resin | | | | | | | | | | | | |
| | Bisphenol F Type | A5 | | | 3.54 | | 10.00 | | | | | | |
| | Epoxy Resin | | | | | | | | | | | | |
| | DCPD Based | A6 | | | | | | | | 3.17 | | | |
| | Resin | | | | | | | | | | | | |
| Curing Agent | Phenolic Curing | B1 | 13.77 | 11.02 | 11.02 | 11.02 | 11.02 | 11.02 | 11.02 | 11.02 | 11.02 | 13.77 | |
| (Curing | Agent (1) | | | | | | | | | | | | |
| Accelerating | Phenolic Curing | B2 | | | | | | | | | | | 12.46 |
| Agent) | Agent (2) | | | | | | | | | | | | |
| | Active Ester Type | B3 | | | | | | | | | | | |
| | Curing Agent | | | | | | | | | | | | |
| | P-d Type | B4 | | | | | | | | | | | |
| | Benzoxazine | | | | | | | | | | | | |
| | Dicyandiamide | B5 | | 0.16 | 0.16 | 0.16 | 0.16 | 0.16 | 0.16 | 0.16 | 0.16 | | |
| | Imidazole | B6 | | 0.03 | 0.03 | 0.03 | 0.03 | 0.03 | 0.03 | 0.03 | 0.03 | | |
| | Triphenyl | B7 | 0.03 | 0.03 | 0.03 | 0.03 | 0.03 | 0.03 | 0.03 | 0.03 | 0.03 | 0.03 | 0.03 |
| | Phosphine | | | | | | | | | | | | |
| | Silica (1) | C1 | 7.53 | 6.91 | 6.32 | 5.52 | 5.52 | 6.44 | 6.44 | 6.92 | 14.98 | 7.38 | 7.20 |
| | Silica (2) | C2 | | | | | | | | | | | |
| | Silica (3) | C3 | | | | | | | | | | | |
| | Silica (4) | C4 | | | | | | | | | | | |
| | Silica (5) | C5 | | | | | | | | | | | |
| | Silica (6) | C6 | | | | | | | | | | | |
| | Synthetic | D | 0.61 | 0.69 | 0.32 | 0.28 | 0.28 | 0.65 | 0.65 | 0.70 | 0.86 | | 0.58 |
| | Hectorite | | | | | | | | | | | | |
| Solvent | DMF | E1 | 49.80 | 51.80 | 20.97 | 19.44 | 19.44 | 48.20 | 48.20 | 51.80 | 56.70 | 43.20 | 47.60 |
| | Toluene | E2 | | | | | | | | | | | |
| Curing Conditions | | F | 180° C. | 180° C. | 180° C. | 180° C. | 180° C. | 180° C. | 180° C. | 180° C. | 180° C. | 180° C. | 180° C. |
| | | | 1 h | 1 h | 1 h | 1 h | 1 h | 1 h | 1 h | 1 h | 1 h | 1 h | 1 h |
| Roughening | With: ◯ | G | ◯ | ◯ | ◯ | ◯ | ◯ | ◯ | ◯ | ◯ | ◯ | ◯ | ◯ |
| Treatment | Without: X | | | | | | | | | | | | |
| Adhesive Strength | kgf/cm | H | 1.2 | 1.2 | 1.2 | 1.2 | 1.2 | 1.1 | 1.1 | 1.1 | 1.4 | 1.2 | 1.1 |
| of Copper | | | | | | | | | | | | | |
| Roughened | kgf/cm | I | 0.82 | 0.84 | 0.88 | 0.78 | 0.80 | 0.80 | 0.82 | 0.80 | 0.9 | 0.47 | 0.78 |
| Adhesive Strength | | | | | | | | | | | | | |
| Surface Roughness | Ra | J1 | 0.06 | 0.06 | 0.08 | 0.10 | 0.10 | 0.08 | 0.08 | 0.10 | 0.14 | 0.06 | 0.15 |
| | Rz | J2 | 0.88 | 0.90 | 0.94 | 1.14 | 1.16 | 0.94 | 0.92 | 1.04 | 1.36 | 0.86 | 1.60 |
| Electrical Property | Dielectric | K1 | 3.1 | 3.1 | 3.1 | 3.2 | 3.2 | 3.2 | 3.2 | 3.1 | 3.1 | 3.2 | 3.1 |
| (1 GHz) | Constant | | | | | | | | | | | | |
| | Dielectric Loss | K2 | 0.014 | 0.010 | 0.012 | 0.016 | 0.016 | 0.013 | 0.013 | 0.014 | 0.010 | 0.014 | 0.014 |
| | Tangent | | | | | | | | | | | | |
| Coefficient of | α 1 (×10⁵/° C.) | L | 5.0 | 4.7 | 4.9 | 5.2 | 5.2 | 5.2 | 5.3 | 5.0 | 3.9 | 5.2 | 5.0 |
| Linear Expansion | α 2 (×10⁵/° C.) | M | 5.6 | 5.2 | 5.4 | 5.8 | 6.2 | 5.6 | 5.7 | 5.5 | 4.8 | 6.2 | 5.7 |
| Tg | (° C.) | N | 189 | 195 | 186 | 181 | 160 | 194 | 193 | 192 | 195 | 189 | 167 |
| Tensile Strength | (MPa) | O | 81 | 95 | 92 | 86 | 90 | 81 | 89 | 80 | 88 | 80 | 82 |
| Tensile Elongation | (%) | P | 7.1 | 10.5 | 9.3 | 8.9 | 9.4 | 7.3 | 7.4 | 6.8 | 5.8 | 4.8 | 8.1 |

TABLE 2

| | | | Comparative Example | | | | | |
|---|---|---|---|---|---|---|---|---|
| | | | 1 | 2 | 3 | 4 | 5 | 6 |
| Epoxy Resin | Biphenyl Based Epoxy Resin (1) | A1 | 15.71 | 15.71 | 15.71 | 15.71 | 15.71 | 15.71 |
| | Biphenyl Based Epoxy Resin (2) | A2 | | | | | | |
| | Biphenyl Based Epoxy Resin (3) | A3 | | | | | | |
| | Bisphenol A Type Epoxy Resin | A4 | | | | | | |
| | Bisphenol F Type Epoxy Resin | A5 | | | | | | |
| | DCPD Based Resin | A6 | | | | | | |
| Curing Agent | Phenolic Curing Agent (1) | B1 | 13.77 | 11.02 | 11.02 | 11.02 | 11.02 | 13.77 |
| (Curing | Phenolic Curing Agent (2) | B2 | | | | | | |
| Accelerating | Active Ester Type Curing Agent | B3 | | | | | | |
| Agent) | P-d Type Benzoxazine | B4 | | | | | | |
| | Dicyandiamide | B5 | | 0.16 | 0.16 | 0.16 | 0.16 | |
| | Imidazole | B6 | | 0.03 | 0.03 | 0.03 | 0.03 | |
| | Triphenyl Phosphine | B7 | 0.03 | 0.03 | 0.03 | 0.03 | 0.03 | 0.03 |
| | Silica (1) | C1 | | | | | | 7.53 |
| | Silica (2) | C2 | | | 6.91 | | | |
| | Silica (3) | C3 | | | | 6.91 | | |
| | Silica (4) | C4 | 7.38 | 6.91 | | | | |
| | Silica (5) | C5 | | | | | 6.91 | |
| | Silica (6) | C6 | | | | | | |
| | Synthetic Hectorite | D | | 0.69 | 0.69 | 0.69 | 0.69 | 0.61 |
| Solvent | DMF | E1 | 43.20 | 51.80 | 51.80 | 51.80 | 51.80 | 49.80 |
| | Toluene | E2 | | | | | | |
| Curing Conditions | | F | 180° C. 1 h | 180° C. 1 h | 180° C. 1 h | 180° C. | 180° C. 1 h | 180° C. |
| | | | | | | 1 h | | 1 h |
| Roughening | | G | ◯ | ◯ | ◯ | ◯ | ◯ | X |
| Treatment | | | | | | | | |
| Adhesive Strength | kgf/cm | H | 0.8 | 0.7 | 0.9 | 0.8 | 0.7 | 1.2 |
| of Copper | | | | | | | | |
| Roughened | kgf/cm | I | 0 | 0.16 | 0 | 0.20 | 0 | 0 |
| Adhesive Strength | | | | | | | | |
| Surface Roughness | Ra | J1 | 0.40 | 0.48 | | 0.44 | | |
| | Rz | J2 | 3.80 | 3.52 | | 3.26 | | |
| Electrical Property | Dielectric Constant | K1 | 3.2 | 3.2 | 3.3 | 3.3 | 3.2 | 3.1 |
| (1 GHz) | Dielectric Loss Tangent | K2 | 0.015 | 0.013 | 0.014 | 0.013 | 0.015 | 0.014 |
| Coefficient of | α 1 (×10⁵/° C.) | L | 5.8 | 5.3 | 5.5 | 5.4 | 5.5 | 5.0 |
| Linear Expansion | α 2 (×10⁵/° C.) | M | 6.5 | 6.0 | 6.3 | 6.1 | 6.2 | 5.6 |
| Tg | (° C.) | N | 175 | 184 | 183 | 184 | 183 | 189 |
| Tensile Strength | (MPa) | O | 68 | 72 | 79 | 78 | 80 | 81 |
| Tensile Elongation | (%) | P | 3.1 | 4.8 | 6.4 | 5.6 | 4.8 | 7.1 |

TABLE 3

| | | | Example | | | | | | | | |
|---|---|---|---|---|---|---|---|---|---|---|---|
| | | | 12 | 13 | 14 | 15 | 16 | 17 | 18 | 19 | 20 |
| Epoxy Resin | Biphenyl Based Epoxy Resin (1) | A1 | 15.71 | 15.71 | 15.71 | | | 9.43 | 9.43 | 12.57 | 15.71 |
| | Biphenyl Based Epoxy Resin (2) | A2 | | | | | | 4.43 | | | |
| | Biphenyl Based Epoxy Resin (3) | A3 | | | | | | | 4.41 | | |
| | Bisphenol A Type Epoxy Resin | A4 | | | | 10.00 | | | | | |
| | Bisphenol F Type Epoxy Resin | A5 | | | | | 10.00 | | | | |
| | DCPD Based Resin | A6 | | | | | | | | 3.17 | |
| Curing Agent | Phenolic Curing Agent (1) | B1 | | | | | | | | | |
| (Curing | Phenolic Curing Agent (2) | B2 | | | | | | | | | |
| Accelerating | Active Ester Type Curing Agent | B3 | 12.74 | 12.74 | 12.74 | 12.74 | 12.74 | 12.74 | 12.74 | 12.74 | 12.74 |
| Agent) | P-d Type Benzoxazine | B4 | | | | | | | | | |
| | Dicyandiamide | B5 | | | | | | | | | |
| | Imidazole | B6 | 0.03 | 0.03 | 0.03 | 0.03 | 0.03 | 0.03 | 0.03 | 0.03 | 0.03 |
| | Triphenyl Phosphine | B7 | 0.03 | 0.03 | 0.03 | 0.03 | 0.03 | 0.03 | 0.03 | 0.03 | 0.03 |
| | Silica (1) | C1 | 12.40 | 19.35 | 43.94 | 9.92 | 9.92 | 11.60 | 11.59 | 12.42 | 12.23 |
| | Silica (2) | C2 | | | | | | | | | |
| | Silica (3) | C3 | | | | | | | | | |
| | Silica (4) | C4 | | | | | | | | | |
| | Silica (5) | C5 | | | | | | | | | |
| | Silica (6) | C6 | | | | | | | | | |
| | Synthetic Hectorite | D | 0.41 | 0.49 | 0.73 | 0.30 | 0.30 | 0.39 | 0.39 | 0.42 | |
| Solvent | DMF | E1 | 20.09 | 22.10 | 40.00 | 14.70 | 14.70 | 18.80 | 18.80 | 20.12 | 18.80 |
| | Toluene | E2 | 6.77 | 6.77 | 6.77 | 6.77 | 6.77 | 6.77 | 6.77 | 6.77 | 6.77 |
| Curing Conditions | | F | 180° C. 1 h | 180° C. | 180° C. | 180° C. | 180° C. | 180° C. | 180° C. | 180° C. | 180° C. |
| | | | | 1 h | 1 h | 1 h | 1 h | 1 h | 1 h | 1 h | 1 h |
| Roughening | | G | ◯ | ◯ | ◯ | ◯ | ◯ | ◯ | ◯ | ◯ | ◯ |
| Treatment | | | | | | | | | | | |
| Adhesive Strength | kgf/cm | H | 1.2 | 1.2 | 1.1 | 1.4 | 1.4 | 1.2 | 1.2 | 1.2 | 1.2 |
| of Copper | | | | | | | | | | | |
| Roughened | kgf/cm | I | 0.76 | 0.80 | 0.76 | 0.84 | 0.86 | 0.84 | 0.80 | 0.78 | 0.69 |
| Adhesive Strength | | | | | | | | | | | |
| Surface Roughness | Ra | J1 | 0.05 | 0.06 | 0.10 | 0.09 | 0.10 | 0.06 | 0.06 | 0.10 | 0.07 |
| | Rz | J2 | 0.92 | 0.94 | 1.24 | 1.05 | 1.12 | 0.92 | 0.98 | 1.02 | 0.94 |
| Electrical Property | Dielectric Constant | K1 | 2.9 | 3.0 | 3.1 | 3.0 | 3.0 | 3.0 | 3.0 | 2.9 | 3.0 |
| (1 GHz) | Dielectric Loss Tangent | K2 | 0.004 | 0.004 | 0.002 | 0.005 | 0.005 | 0.005 | 0.005 | 0.003 | 0.004 |
| Coefficient of | α 1 (×10⁵/° C.) | L | 4.6 | 4.4 | 1.6 | 4.8 | 5.1 | 4.7 | 4.6 | 4.8 | 5.3 |
| Linear Expansion | α 2 (×10⁵/° C.) | M | 5.8 | 5.2 | 2.2 | 5.9 | 6.2 | 5.9 | 5.8 | 5.9 | 6.2 |
| Tg | (° C.) | N | 170 | 170 | 170 | 169 | 150 | 165 | 166 | 164 | 170 |
| Tensile Strength | (MPa) | O | 98 | 105 | 90 | 102 | 88 | 89 | 92 | 82 | 93 |
| Tensile Elongation | (%) | P | 5.4 | 4.5 | 2.3 | 5.6 | 6.5 | 4.9 | 5.1 | 4.2 | 4.8 |

TABLE 4

| | | | Comparative Example | | | | | |
|---|---|---|---|---|---|---|---|---|
| | | | 7 | 8 | 9 | 10 | 11 | 12 |
| Epoxy Resin | Biphenyl Based Epoxy Resin (1) | A1 | 15.71 | 15.71 | 15.71 | 15.71 | 15.71 | 15.71 |
| | Biphenyl Based Epoxy Resin (2) | A2 | | | | | | |
| | Biphenyl Based Epoxy Resin (3) | A3 | | | | | | |
| | Bisphenol A Type Epoxy Resin | A4 | | | | | | |
| | Bisphenol F Type Epoxy Resin | A5 | | | | | | |
| | DCPD Based Resin | A6 | | | | | | |
| Curing Agent | Phenolic Curing Agent (1) | B1 | | | | | | |
| (Curing | Phenolic Curing Agent (2) | B2 | | | | | | |
| Accelerating | Active Ester Type Curing Agent | B3 | 12.74 | 12.74 | 12.74 | 12.74 | 12.74 | 12.74 |
| Agent) | P-d Type Benzoxazine | B4 | | | | | | |
| | Dicyandiamide | B5 | | | | | | |
| | Imidazole | B6 | 0.03 | 0.03 | 0.03 | 0.03 | 0.03 | 0.03 |
| | Triphenyl Phosphine | B7 | 0.03 | 0.03 | 0.03 | 0.03 | 0.03 | 0.03 |
| | Silica (1) | C1 | | | | | | 12.40 |
| | Silica (2) | C2 | | | 12.40 | | | |
| | Silica (3) | C3 | | | | 12.40 | | |
| | Silica (4) | C4 | 12.23 | 12.40 | | | | |
| | Silica (5) | C5 | | | | | 12.40 | |
| | Silica (6) | C6 | | | | | | |
| | Synthetic Hectorite | D | | 0.41 | 0.41 | 0.41 | 0.41 | 0.41 |
| Solvent | DMF | E1 | 18.80 | 20.09 | 20.09 | 20.09 | 20.09 | 20.09 |
| | Toluene | E2 | 6.77 | 6.77 | 6.77 | 6.77 | 6.77 | 6.77 |
| Curing Conditions | | F | 180° C. | 180° C. 1 h | 180° C. | 180° C. 1 h | 180° C. 1 h | 180° C. 1 h |
| | | | 1 h | | 1 h | | | |
| Roughening | | G | ◯ | ◯ | ◯ | ◯ | ◯ | X |
| Treatment | | | | | | | | |
| Adhesive Strength | kgf/cm | H | 0.8 | 0.7 | 0.8 | 0.8 | 0.8 | 1.2 |
| of Copper | | | | | | | | |
| Roughened | kgf/cm | I | 0 | 0.20 | 0 | 0.18 | 0 | 0 |
| Adhesive Strength | | | | | | | | |
| Surface Roughness | Ra | J1 | 0.60 | 0.52 | | 0.48 | | |
| | Rz | J2 | 3.68 | 3.80 | | 3.45 | | |
| Electrical Property | Dielectric Constant | K1 | 3.0 | 3.0 | 3.0 | 3.0 | 3.0 | 2.9 |
| (1 GHz) | Dielectric Loss Tangent | K2 | 0.004 | 0.004 | 0.005 | 0.004 | 0.005 | 0.004 |
| Coefficient of | α 1 (×10⁵/° C.) | L | 5.9 | 5.4 | 5.4 | 5.3 | 5.5 | 4.6 |
| Linear Expansion | α 2 (×10⁵/° C.) | M | 6.6 | 6.2 | 6.3 | 6.2 | 6.4 | 5.8 |
| Tg | (° C.) | N | 159 | 160 | 160 | 159 | 161 | 170 |
| Tensile Strength | (MPa) | O | 72 | 74 | 65 | 67 | 78 | 98 |
| Tensile Elongation | (%) | P | 3.2 | 3.5 | 3.0 | 3.4 | 3.8 | 5.4 |

TABLE 5

| | | | Example | | | | | | | | |
|---|---|---|---|---|---|---|---|---|---|---|---|
| | | | 21 | 22 | 23 | 24 | 25 | 26 | 27 | 28 | 29 |
| Epoxy Resin | Biphenyl Based Epoxy Resin (1) | A1 | 15.71 | 15.71 | 15.71 | | | 9.43 | 9.43 | 12.57 | 15.71 |
| | Biphenyl Based Epoxy Resin (2) | A2 | | | | | | 4.43 | | | |
| | Biphenyl Based Epoxy Resin (3) | A3 | | | | | | | 4.41 | | |
| | Bisphenol A Type Epoxy Resin | A4 | | | | 10.00 | | | | | |
| | Bisphenol F Type Epoxy Resin | A5 | | | | | 10.00 | | | | |
| | DCPD Based Resin | A6 | | | | | | | | 3.17 | |
| Curing Agent | Phenolic Curing Agent (1) | B1 | | | | | | | | | |
| (Curing | Phenolic Curing Agent (2) | B2 | | | | | | | | | |
| Accelerating | Active Ester Type Curing Agent | B3 | | | | | | | | | |
| Agent) | P-d Type Benzoxazine | B4 | 14.88 | 14.88 | 14.88 | 14.88 | 14.88 | 14.88 | 14.88 | 14.88 | 14.88 |
| | Dicyandiamide | B5 | 0.17 | 0.17 | 0.17 | 0.17 | 0.17 | 0.17 | 0.17 | 0.17 | 0.17 |
| | Imidazole | B6 | 0.03 | 0.03 | 0.03 | 0.03 | 0.03 | 0.03 | 0.03 | 0.03 | 0.03 |
| | Triphenyl Phosphine | B7 | 0.03 | 0.03 | 0.03 | 0.03 | 0.03 | 0.03 | 0.03 | 0.03 | 0.03 |
| | Silica (1) | C1 | 13.48 | 21.09 | 48.40 | 10.98 | 10.98 | 12.89 | 12.88 | 13.49 | 13.28 |
| | Silica (2) | C2 | | | | | | | | | |
| | Silica (3) | C3 | | | | | | | | | |
| | Silica (4) | C4 | | | | | | | | | |
| | Silica (5) | C5 | | | | | | | | | |
| | Silica (6) | C6 | | | | | | | | | |
| | Synthetic Hectorite | D | 0.45 | 0.53 | 0.81 | 0.37 | 0.37 | 0.43 | 0.43 | 0.45 | |
| Solvent | DMF | E1 | 32.30 | 34.82 | 63.77 | 24.34 | 24.34 | 27.72 | 27.71 | 29.31 | 26.11 |
| | Toluene | E2 | | | | | | | | | |
| Curing Conditions | | F | 180° C. 1 h | 180° C. | 180° C. | 180° C. | 180° C. | 180° C. | 180° C. | 180° C. | 180° C. |
| | | | | 1 h | 1 h | 1 h | 1 h | 1 h | 1 h | 1 h | 1 h |
| Roughening | | G | ◯ | ◯ | ◯ | ◯ | ◯ | ◯ | ◯ | ◯ | ◯ |
| Treatment | | | | | | | | | | | |
| Adhesive Strength | kgf/cm | H | 1.3 | 1.2 | 1.1 | 1.3 | 1.4 | 1.2 | 1.2 | 1.0 | 1.2 |
| of Copper | | | | | | | | | | | |
| Roughened | kgf/cm | I | 0.80 | 0.78 | 0.76 | 0.80 | 0.84 | 0.80 | 0.80 | 0.76 | 0.65 |
| Adhesive Strength | | | | | | | | | | | |
| Surface Roughness | Ra | J1 | 0.08 | 0.09 | 0.13 | 0.10 | 0.10 | 0.09 | 0.10 | 0.10 | 0.07 |
| | Rz | J2 | 1.00 | 1.08 | 1.24 | 1.08 | 1.11 | 1.05 | 1.01 | 1.06 | 0.90 |
| Electrical Property | Dielectric Constant | K1 | 3.3 | 3.4 | 3.4 | 3.3 | 3.3 | 3.3 | 3.3 | 3.3 | 3.3 |
| (1 GHz) | Dielectric Loss Tangent | K2 | 0.004 | 0.003 | 0.002 | 0.007 | 0.007 | 0.005 | 0.005 | 0.003 | 0.004 |
| Coefficient of | α 1 (×10⁵/° C.) | L | 4.6 | 4.2 | 1.5 | 4.6 | 4.7 | 4.5 | 4.7 | 4.8 | 5.2 |
| Linear Expansion | α 2 (×10⁵/° C.) | M | 5.6 | 5.1 | 2.1 | 5.7 | 5.8 | 5.5 | 5.8 | 5.9 | 6.3 |
| Tg | (° C.) | N | 181 | 182 | 180 | 178 | 161 | 178 | 178 | 172 | 179 |
| Tensile Strength | (MPa) | O | 110 | 116 | 96 | 105 | 94 | 106 | 102 | 91 | 96 |
| Tensile Elongation | (%) | P | 5.8 | 4.3 | 2.8 | 5.9 | 6.6 | 5.1 | 5.4 | 4.5 | 4.9 |

TABLE 6

| | | | Comparative Example | | | | | | | | |
|---|---|---|---|---|---|---|---|---|---|---|---|
| | | | 13 | 14 | 15 | 16 | 17 | 18 | 19 | 20 | 21 |
| Epoxy Resin | Biphenyl Based Epoxy Resin (1) | A1 | 15.71 | 15.71 | 15.71 | 15.71 | 15.71 | 15.71 | 15.71 | 15.71 | 15.71 |
| | Biphenyl Based Epoxy Resin (2) | A2 | | | | | | | | | |
| | Biphenyl Based Epoxy Resin (3) | A3 | | | | | | | | | |
| | Bisphenol A Type Epoxy Resin | A4 | | | | | | | | | |
| | Bisphenol F Type Epoxy Resin | A5 | | | | | | | | | |
| | DCPD Based Resin | A6 | | | | | | | | | |
| Curing Agent | Phenolic Curing Agent (1) | B1 | | | | | | | | | |
| (Curing | Phenolic Curing Agent (2) | B2 | | | | | | | | | |
| Accelerating | Active Ester Type Curing Agent | B3 | | | | | | | 12.74 | 12.74 | 12.74 |
| Agent) | P-d Type Benzoxazine | B4 | 14.88 | 14.88 | 14.88 | 14.88 | 14.88 | 14.88 | | | |
| | Dicyandiamide | B5 | 0.17 | 0.17 | 0.17 | 0.17 | 0.17 | 0.17 | | | |
| | Imidazole | B6 | 0.03 | 0.03 | 0.03 | 0.03 | 0.03 | 0.03 | 0.03 | 0.03 | 0.03 |
| | Triphenyl Phosphine | B7 | 0.03 | 0.03 | 0.03 | 0.03 | 0.03 | 0.03 | 0.03 | 0.03 | 0.03 |
| | Silica (1) | C1 | | | | | | 13.48 | | | |
| | Silica (2) | C2 | | | 13.48 | | | | | | |
| | Silica (3) | C3 | | | | 13.48 | | | | | |
| | Silica (4) | C4 | 13.28 | 13.48 | | | | | | | |
| | Silica (5) | C5 | | | | | 13.48 | | | | |
| | Silica (6) | C6 | | | | | | | 12.40 | 19.35 | 43.94 |
| | Synthetic Hectorite | D | | 0.45 | 0.45 | 0.45 | 0.45 | 0.45 | 0.41 | 0.49 | 0.73 |
| Solvent | DMF | E1 | 26.11 | 30.00 | 30.00 | 30.00 | 30.00 | 32.30 | 20.09 | 22.10 | 40.00 |
| | Toluene | E2 | | | | | | | 6.77 | 6.77 | 6.77 |
| Curing Conditions | | F | 180° C. 1 h | 180° C. | 180° C. | 180° C. | 180° C. | 180° C. | 180° C. | 180° C. | 180° C. |
| | | | | 1 h | 1 h | 1 h | 1 h | 1 h | 1 h | 1 h | 1 h |
| Roughening | | G | ◯ | ◯ | ◯ | ◯ | ◯ | X | ◯ | ◯ | ◯ |
| Treatment | | | | | | | | | | | |
| Adhesive Strength | kgf/cm | H | 0.8 | 0.9 | 0.7 | 0.7 | 0.7 | 1.3 | 1.1 | 1.2 | 1.3 |
| of Copper | | | | | | | | | | | |
| Roughened | kgf/cm | I | 0 | 0.10 | 0 | 0.12 | 0 | 0 | 0.64 | 0.67 | 0.72 |
| Adhesive Strength | | | | | | | | | | | |
| Surface Roughness | Ra | J1 | 0.72 | 0.64 | | 55.00 | | | 0.98 | 1.02 | 1.06 |
| | Rz | J2 | 3.88 | 3.58 | | 3.52 | | | 5.62 | 6.05 | 7.91 |
| Electrical Property | Dielectric Constant | K1 | 3.3 | 3.3 | 3.3 | 3.3 | 3.3 | 3.3 | 3.3 | 3.4 | 3.4 |
| (1 GHz) | Dielectric Loss Tangent | K2 | 0.005 | 0.004 | 0.005 | 0.004 | 0.005 | 0.004 | 0.004 | 0.004 | 0.003 |
| Coefficient of | α 1 (×10⁵/° C.) | L | 4.9 | 4.8 | 5.0 | 5.0 | 4.9 | 4.6 | 5.0 | 4.9 | 2.2 |
| Linear Expansion | α 2 (×10⁵/° C.) | M | 5.9 | 5.7 | 6.0 | 6.1 | 6.0 | 5.6 | 6.0 | 5.6 | 2.6 |
| Tg | (° C.) | N | 171 | 170 | 172 | 171 | 171 | 181 | 170 | 170 | 170 |
| Tensile Strength | (MPa) | O | 78 | 82 | 84 | 77 | 75 | 110 | 98 | 98 | 86 |
| Tensile Elongation | (%) | P | 5.1 | 5.4 | 4.8 | 4.4 | 4.1 | 5.8 | 4.9 | 3.8 | 1.6 |

TABLE 7

| | nT: Example n, nF: Comparative Example n | |
|---|---|---|
| A1 | Epoxy Resin | Biphenyl Based Epoxy Resin (1) |
| A2 | | Biphenyl Based Epoxy Resin (2) |
| A3 | | Biphenyl Based Epoxy Resin (3) |
| A4 | | Bisphenol A Type Epoxy Resin |
| A5 | | Bisphenol F Type Epoxy Resin |
| A6 | | DCPD Based Resin |
| B1 | Curing Agent | Phenolic Curing Agent (1) |
| | (Curing Accelerating Agent) | |
| B2 | | Phenolic Curing Apent (2) |
| B3 | | Active Ester Type Curing Agent |
| B4 | | P-d Type Benzoxazine |
| B5 | | Dicyandiamide |
| B6 | | Imidazole |
| B7 | | Triphenyl Phosphine |
| C1 | Inorganic Compound | Silica (1) |
| C2 | | Silica (2) |
| C3 | | Silica (3) |
| C4 | | Silica (4) |
| C5 | | Silica (5) |
| C6 | | Silica (6) |
| D | | Synthetic Hectorite |
| E1 | Solvent | DMF |
| E2 | | Toluene |
| F | Curing Conditions | |
| G | Roughening Treatment | With: ο Without: X |
| H | Adhesive Strength of Copper | kgf/cm |
| I | Roughened Adhesive Strength | kgf/cm |
| J1 | Surface Roughness | Ra |
| J2 | | Rz |
| K1 | Electrical Property (1 GHz) | Dielectric Constant |
| K2 | | Dielectric Loss Tangent |
| L | Coefficient of | α1 (×105/° C.) |
| | Linear Expansion | |
| M | | α2 (×105/° C.) |
| N | Tg | (° C.) |
| O | Tensile Strength | (MPa) |
| P | Tensile Elongation | (%) |

Silica (1): silica 1-FX manufactured by Tatsumori LTD having surface treatment with imidazole silane (IM-1000, manuafctured by Nikko Materials)
Silica (2): silica 1-FX manufactured by Tatsumori LTD having surface treatment with epoxysilane (KBM-403 manufactured by Shin-Etsu Chemicals Co., Ltd.)
Silica (3): silica 1-FX manufactured by Tatsumori LTD having surface treatment with vinylsilane (KBM-1003 manufactured by Shin-Etsu chemical Co., Ltd.)
Silica (4): silica 1-FX manufactured by Tatsumori LTD (with no surface treatment)
Silica (5): silica B-21 manufactured by Tatsumori LTD (with no surface treatment)
Silica (6): silica FB-8S manufactured by DENKI KAGAKU KOGYO K.K. having surface treatment with imidazole silane (IM-1000, manuafctured by Nikko Materials)

1-12. (canceled)

13. A resin composition comprising:
an epoxy resin;
a curing agent for the epoxy resin; and
a silica, wherein
the silica is included at a proportion of 0.1 to 80 parts by weight to a mixture consisting of the epoxy resin and the curing agent for the epoxy resin 100 parts by weight, and the silica is treated with an imidazole silane, and has a mean particle diameter not more than 5 micrometers.

14. The resin composition according to claim 13, wherein the silica has a mean particle diameter not more than 1 micrometer.

15. The resin composition according to claim 13, wherein the silica has a maximum particle diameter not more than 5 micrometers.

16. The resin composition according to claim 14, wherein the silica has a maximum particle diameter not more than 5 micrometers.

17. The resin composition according to claim 13, further comprising an organized layered-silicate at a proportion of 0.01 to 50 parts by weight to a mixture consisting of the epoxy resin and the curing agent for the epoxy resin 100 parts by weight.

18. The resin composition according to claim 14, further comprising an organized layered-silicate at a proportion of 0.01 to 50 parts by weight to a mixture consisting of the epoxy resin and the curing agent for the epoxy resin 100 parts by weight.

19. The resin composition according to claim 15, further comprising an organized layered-silicate at a proportion of 0.01 to 50 parts by weight to a mixture consisting of the epoxy resin and the curing agent for the epoxy resin 100 parts by weight.

20. The resin composition according to claim 16, further comprising an organized layered-silicate at a proportion of 0.01 to 50 parts by weight to a mixture consisting of the epoxy resin and the curing agent for the epoxy resin 100 parts by weight.

21. A sheet-like formed body obtained by impregnation of the resin composition according to claim 13, to a porous base material.

22. A prepreg obtained by impregnation of the resin composition according to claim 13, to a porous base material.

23. A cured body obtained by performing a roughening treatment to a cured body of the resin obtained by heated-curing of the resin composition according to claim 13, the cured body having a surface roughness Ra not more than 0.2 micrometers and a surface roughness Rz not more than 2.0 micrometers.

24. A cured body obtained by performing a roughening treatment to a cured body of the resin obtained by heated-curing of the resin composition according to claim 21, the cured body having a surface roughness Ra not more than 0.2 micrometers and a surface roughness Rz not more than 2.0 micrometers.

25. A cured body obtained by performing a roughening treatment to a cured body of the resin obtained by heated-curing of the resin composition according to claim 22, the cured body having a surface roughness Ra not more than 0.2 micrometers and a surface roughness Rz not more than 2.0 micrometers.

26. The cured body according to claim 23, obtained by performing a swelling treatment to the cured body of the resin before a roughening treatment.

27. A laminated substrate obtained by formation of a metal layer on at least one side of the cured body according to claim 26.

28. The laminated substrate according to claim 27, having the metal layer formed thereonto as a circuit.

29. A multilayered laminate comprising at least one of a layer obtained by performing roughening treatment to a resin laminated cured body obtained by heating to cure any one of the resin composition according to claim 13, the sheet-like formed body, or the prepreg obtained by impregnation of the resin composition according to claim 13, to a porous base material, the multilayered laminate having a surface roughness Ra not more than 0.2 micrometers and a surface roughness Rz not more than 2.0 micrometers.
